(19) United States
(12) Patent Application Publication
(10) Pub. No.: US 2022/0065890 A1
(43) Pub. Date: Mar. 3, 2022

(54) Device, System and Method for Fluid Delivery for Sequencing

(71) Applicant: LIFE TECHNOLOGIES CORPORATION, Carlsbad, CA (US)

(72) Inventors: Albert L. Carrillo, South San Francisco, CA (US); John Donohue, Southbury, CT (US)

(21) Appl. No.: 17/524,840

(22) Filed: Nov. 12, 2021

Related U.S. Application Data
(63) Continuation of application No. PCT/US2020/035086, filed on May 29, 2020.
(60) Provisional application No. 62/855,816, filed on May 31, 2019.

(51) Int. Cl. G01N 35/10; G01N 35/00; B01L 3/00

(52) U.S. Cl. CPC G01N 35/1097; B01L 2300/0887; G01N 35/00693; B01L 3/527; B01L 3/563; B01L 3/502715; G01N 35/1004; G01N 2035/1025; B01L 2200/16; B01L 2200/028; B01L 2300/0877; B01L 2400/0487; B01L 2400/082; B01L 2400/0622; B01L 2400/0655; B01L 2300/123; B01L 2300/0883; G01N 35/1002

(57) ABSTRACT

Various embodiments of a fluidic system of the present teachings are configured to execute a sequence of fluidic operations over the course of a next generation sequencing analysis for the sequential delivery of various solutions used over the course of analysis to a multilane sensor device. Exemplary fluidic operations include washing, priming and nucleotide reagent delivery through a fluidic multiplexer block that is configured to provide independent fluid distribution to each lane of a multilane sensor device used for detection during an analysis. Accordingly, any number or combination of lanes can be used during an analysis, so that during an analysis one lane in any position can be used singly during a run, all four lanes can be used simultaneously during a run, or any combination of lanes can be used simultaneously during a run.

### CROSS REFERENCE TO RELATED APPLICATIONS

This application is a continuation of PCT application number PCT/US2020/035086, filed May 29, 2020. PCT/US2020/035086 claims benefit of U.S. Provisional Application No. 62/855,861 filed May 31, 2019. All applications referenced in this section are incorporated herein by reference, each in its entirety.

### OVERVIEW

Next-generation sequencing (NGS) is a high-throughput methodology that enables rapid sequencing of the base pairs in DNA or RNA samples. The scale and efficiency of NGS impacts a broad range of applications, including gene expression profiling, chromosome counting, detection of epigenetic changes, and molecular analysis. Accordingly, the power of NGS is being harnessed by researchers in a number of disciplines to accelerate the pace of discovery and enable the future of personalized medicine.

To accommodate an increasing pace of discovery, demands on NGS systems for increasing scale and throughput are also increasing. Such increase in scale and throughput is accompanied by a demand for sample-in-answer out solutions, so that automated quality control as well as scale are considerations for NGS systems. As such, there is a need in the art for NGS fluidic systems and related components to meet the demand.

### BRIEF DESCRIPTION OF THE DRAWINGS

A better understanding of the features and advantages of what is disclosed herein may be obtained by reference to the following detailed description, and by reference to the accompanying drawings, of which:

FIG. 1 is an exploded view that illustrates generally a fluidic multiplexer block.

FIG. 2 is an isometric view that illustrates generally a fluidic multiplexer unit of a fluidic multiplexer block, such as the fluidic multiplexer block of FIG. 1.

FIG. 3A is a perspective view that illustrates generally a multilane sensor device.

FIG. 3B is a schematic representation that illustrates generally the fluidic integration between a fluidic multiplexer unit and a selected lane of a multilane sensor device.

FIG. 4 is an isometric view that illustrates generally the integration of fluidic interface blocks with a fluidic multiplexer block, such as the fluidic multiplexer block of FIG. 1.

FIG. 5A is an isometric view that illustrates generally a fluidic interface block.

FIG. 5B is a section view that illustrates generally the seal formed between fluid lines of a fluidic interface block and ports of a fluidic multiplexer unit.

FIG. 6 is a schematic representation that illustrates generally a fluidic system of a sequencing system.

FIG. 7 is a back isometric view that illustrates generally a fluidic multiplexer block clamp assembly including a fluidic multiplexer block clamp with a fluidic multiplexer block assembly mounted therein.

FIG. 8A is a section view that illustrates generally the integration of an electrode into a fluidic multiplexer unit. FIG. 8B is an expanded view of the electrode of FIG. 8A.

FIG. 9 is a front isometric view that illustrates generally a fluidic multiplexer block clamp assembly that includes a fluidic multiplexer block clamp with a fluidic multiplexer block assembly mounted therein.

FIG. 10 is a section view that illustrates generally an assembly of a fluidic multiplexer block in a fluidic multiplexer block clamp mounted to a multilane sensor device that is positioned in a sensor device mounting assembly.

FIG. 11 is an expanded isometric view that illustrates generally the mounting of a fluidic multiplexer block to a multilane sensor device.

FIG. 12 is a block diagram that illustrates generally a sequencing system.

FIG. 13 is a perspective view that illustrates generally a sequencing system.

FIG. 14 is a perspective view that illustrates generally a container cabinet of a sequencing system.

FIG. 15 illustrates generally a flow diagram of a method for automated fluid delivery in a sequencing system.

### DETAILED DESCRIPTION

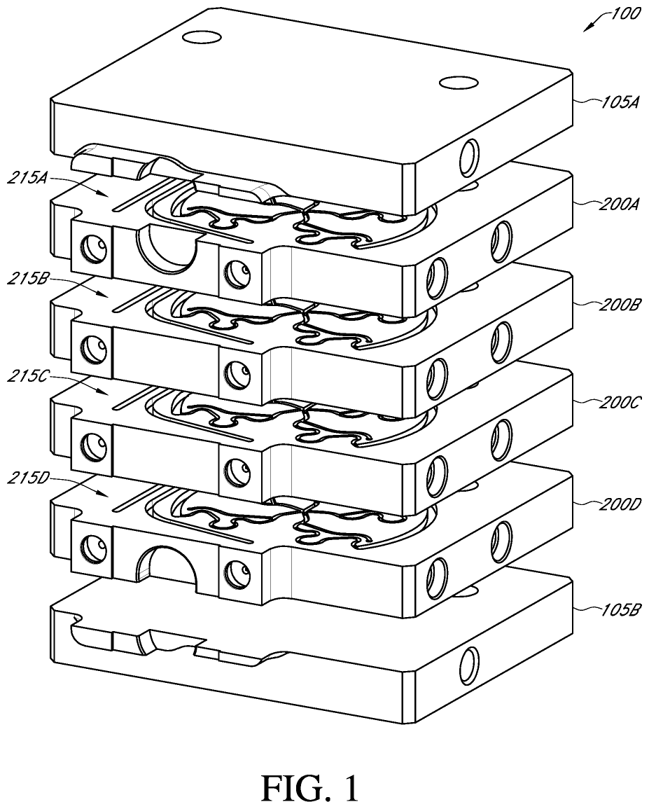

FIG. 1 illustrates generally an exploded view of fluidic multiplexer block 100, which as a component of a fluidic system of an integrated next generation sequencing system, can provide distribution of various solutions used during analysis to a multilane sensor device. Various embodiments of a fluidic system disclosed herein are configured to execute a sequence of fluidic operations for the sequential delivery of various solutions to a multilane sensor device over the course of a next generation sequencing analysis. Exemplary fluidic operations include washing, priming and nucleotide reagent delivery through a fluidic multiplexer block, such as fluidic multiplexer block 100 of FIG. 1. Such a fluidic multiplexer block is configured to provide independent fluid distribution to each lane of a multilane sensor device used for detection during an analysis. According to the present teachings, any number or combination of lanes can be used during an analysis, so that during an analysis one lane in any position can be used singly during a run, all lanes can be used simultaneously during a run, or any combination of lanes can be used simultaneously during a run. Using a fluidic multiplexer block of the present teachings for fluid distribution to a multilane sensor device during a sequence of fluidic operations can avoid cross-contamination of solutions used during analysis in various fluidic compartments, as well as providing sharp transitions between reagent fluid streams during an analysis. Additionally, various embodiments of a fluidic multiplexer block can provide a constant electrolyte fluidic environment for a reference electrode, thereby providing a constant stable reference voltage for a multilane sensor device.

As depicted in FIG. 1, fluidic multiplexer block 100 includes fluidic multiplexer units 200A through 200D, as well as first end cover 105A and second end cover 105B. According to the present teachings, each fluidic multiplexer unit has a fluidic multiplexer circuit formed within the body of fluidic multiplexer unit. Accordingly, as depicted in FIG. 1, each of fluidic multiplexer units 200A through 200D has a fluidic multiplexer circuit 215A through 215D formed within the body of each fluidic multiplexer unit. As will be provided subsequently in more detail herein, each fluidic multiplexer unit in fluidic multiplexer block 100 is independently in controllable fluid communication with one of each of a flow cell lane of a multilane sensor device. Accordingly, a first lane of a multilane sensor device can be fluidically integrated to fluidic multiplexer unit 200A, while a second lane can be fluidically integrated to fluidic multiplexer unit 200B, and a third lane can be fluidically integrated to fluidic multiplexer unit 200C, while a fourth lane can be fluidically integrated to fluidic multiplexer unit 200D. Moreover, any number or combination of lanes can be used during an analysis, so that during the set-up of an analysis, an end user can select one lane in any position used singly during a run, all lanes used simultaneously during a run in an end-user specified order, or any combination of lanes to be used simultaneously during a run an end-user specified order.

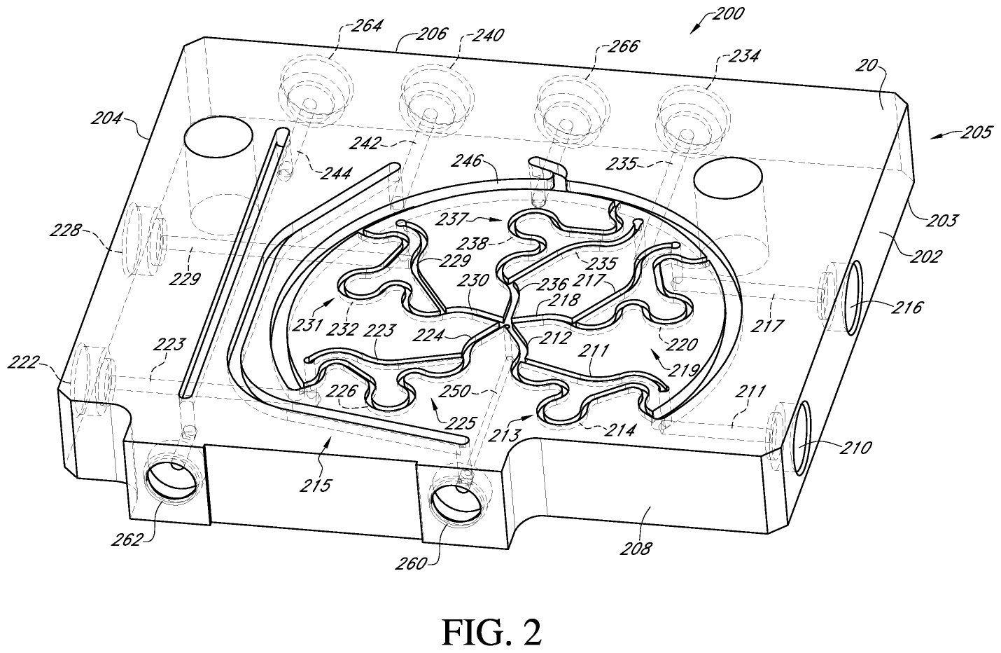

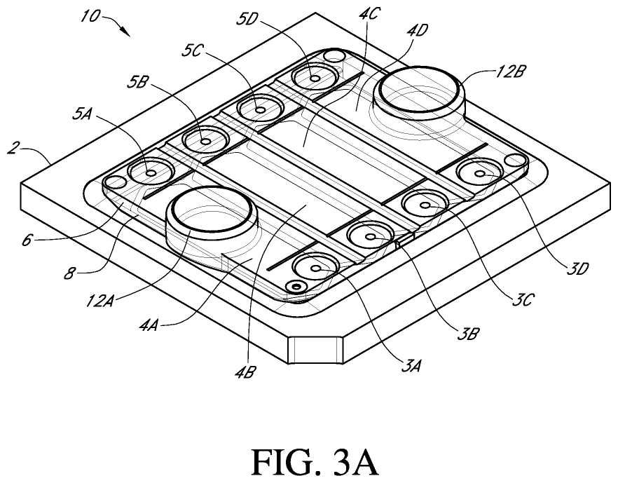

FIG. 2 illustrates generally an embodiment of fluidic multiplexer unit 200 that accommodates four input reagents, and a calibration solution in each of five fluidic branches, as well as having a distribution channel for a wash solution. Fluidic circuit 215 is formed in substrate 205, which has first surface 201 and opposing second surface 203. As depicted in FIG. 2, first surface 201 and opposing second surface 203 are substantially parallel to one another. Fluidic multiplexer unit 200 can have first fluidic interface side 202, with opposing second fluidic interface side 204. As depicted in FIG. 2, third fluidic interface side 206 joins the first and second interface edges on one side, while fourth fluidic interface side 208 joins first and second interface edges on the opposing side of third fluidic interface side 206. Substrate 205 can be constructed from a variety of materials, such as glass, ceramics, and plastics. Exemplary polymeric materials include polycarbonate, polymethyl methacrylate, polyether imide and polyimide. Reagent Inlet ports 210,216,222, and 228, as well as calibration solution inlet port 234 are in fluid communication with inlet channels 211,217,223,229, and 235, respectively. Inlet channels 211,217,223,229, are in fluid communication with curvilinear channels 213,219,225,231, and 235, respectively of each of five fluidic branches. Finally, wash solution inlet port 240 is in fluid communication with wash solution channel 242.

As depicted in FIG. 2, each inlet channel forms a tee junction with each curvilinear channel, so that each curvilinear channel consists of two branches. Such a tee junction forming two branches is depicted in FIG. 2, in which inlet channel 211 tees into curvilinear channel 213, forming first branch channel 212 and second branch channel 214. Similarly, inlet channel 217 tees into curvilinear channel 219, forming first branch channel 218 and second branch channel 220, while inlet channel 223 tees into curvilinear channel 225, forming first branch channel 224 and second branch channel 226. Additionally, inlet channel 229 tees into curvilinear channel 231, forming first branch channel 230 and second branch channel 232. Finally, inlet channel 235 tees into curvilinear channel 237, forming first branch channel 236 and second branch channel 238. First branch channels 212,218,224,230 and 236 of curvilinear channels 213,219,225,231, and 237, respectively, of the five fluidic branches are in fluid communication with center channel 250. As depicted in FIG. 2, central channel 250 is in fluid communication with sensor device interface inlet connector port 260, which is in fluid communication with a sensor inlet port (not shown). Additionally, wash solution inlet port 240 is in fluid communication with wash solution channel 242, which is also in fluid communication with sensor device interface inlet connector port 260. Sensor device interface outlet connector port 262 is in fluid communication with a sensor outlet port (not shown), as well as sensor device waste channel 244. Sensor device waste channel 244 is in fluid communication with a sensor device waste receptacle (not shown), which is connected to fluidic multiplexer unit 200 through sensor device waste port outlet 264. Each of second branch channels 214,220,226,232, and 238 of curvilinear channels 213,219,225,231, and 237, respectively, are in fluid communication with main waste channel 246, which is in fluid communication with a main waste receptacle (not shown), which is connected to fluidic multiplexer unit 200 through main waste outlet port 266.

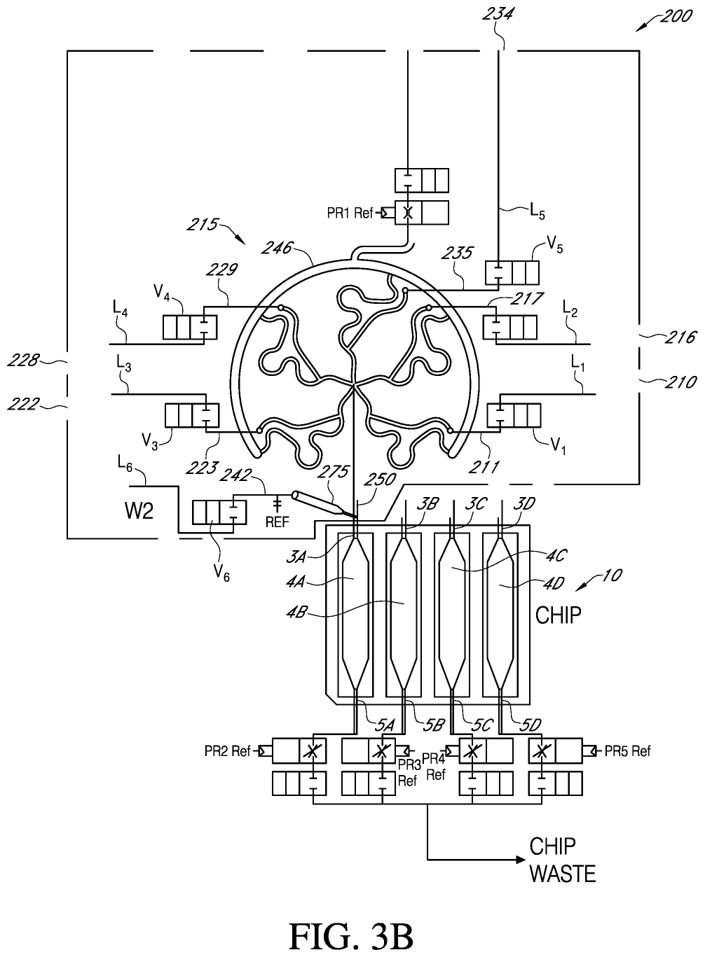

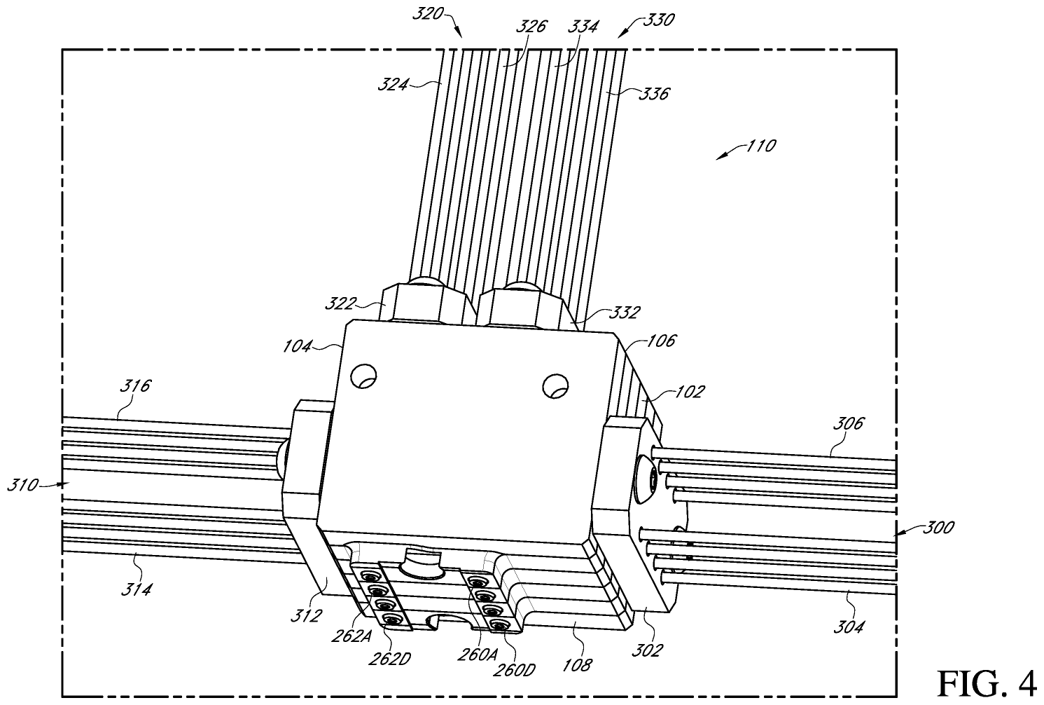

FIG. 3A is a perspective view that illustrates generally a multilane sensor device, such as a microarray device including a flow cell. For example, as depicted in FIG. 3A, sensor device 10 includes die 4, which is mounted upon substrate 2. Die 4 can have a plurality of microwells in fluid communication with a sensor array. As used herein, an “array” is a planar arrangement of elements such as sensors or microwells. The array may be one or two dimensional. A one-dimensional array can be an array having one column (or row) of elements in the first dimension and a plurality of columns (or rows) in the second dimension. The number of columns (or rows) in the first and second dimensions may or may not be the same. Further, embodiments of a sensor device can include a plurality of microwells, which are disposed over an array of field effect transistors (FETs) sensors. In various embodiments of a sensor device, a microwell can be a reaction chamber that provides a containment or confinement region for sequencing. In that regard, a microwell array can include a plurality of microwells loaded with one or more polymeric particles or beads prepared for sequencing a target polynucleotide sample, each loaded microwell disposed over at least one FET sensor. In various embodiments of a sensor device, a FET sensor can be a chemically-sensitive FET (chemFET). For various embodiments of a sensor device, a FET sensor can be an ion-sensitive FET (ISFET). Both a chemFET and an ISFET sensor can have the structural analog of a MOSFET transistor, in which the charge on the gate electrode results from a chemical process, such as the incorporation of a nucleotide during sequencing-by-synthesis. In that regard, an ISFET can be used for measuring protons released (i.e. pH) in a microwell as a result of nucleotide incorporation during a sequencing reaction. A sensor device of the present teachings, such as sensor device 10 of FIG. 3A, can include an array of 10², 10³, 10⁴, 10⁵, 10⁶, 10⁷ or more FET sensors.

Flow cell 6 of FIG. 3A is securely mounted over substrate 2, providing a volume over die 4. In an example, flow cell 6 includes a set of fluid inlets, such as inlets 3A-3D, and a set of fluid outlets, such as outlets 5A-5D, as depicted in FIG. 3A. Flow cell 6 can be divided into lanes, such as lanes 4A-4D, where each lane is individually in fluid communication with a respective fluid inlet and fluid outlet. For example, as depicted in FIG. 3A, lane 4A is in fluid communication with inlet 3A and outlet 5A. As illustrated, sensor device 10 includes four lanes. Alternatively, the sensor device 10 can include less than four lanes or more than four lanes. For example, sensor device 10 can include between 1 and 10 lanes, such as between 2 and 8 lanes, or 4 to 6 lanes. For a sensor device of the present teachings, the lanes of a multilane sensor device can be fluidically isolated from each other. As such, the lanes, such as lanes 4A-4C of FIG. 3A, can be used at separate times, or concurrently, depending upon aspects of an end-user defined sequencing run plan. As will be provided subsequently in more detail herein, sensor device 10 can further include guides structures, such as alignment pins 12A and 12B, for example, formed as part of the flow cell 1406. Alignment pins 12A and 12B can engage complementary structures on a fluidic multiplexer block. Such alignment pins can assist with aligning the fluid inlets and fluid outlets, such as 3A-3D and 5A-5D of FIG. 3A, respectively with associated ports on a fluidic multiplexer block, such as fluidic multiplexer block 100 of FIG. 1. According to the present teachings, an automated fluidic system can provide a sequential order of flows of nucleotide reagents through a flow cell, such as flow cell 6 of FIG. 3A, in which each reagent includes a single type of nucleotide. As previously described herein, In response to nucleotide addition during a sequencing reaction, the pH within the local environment of a microwell can change, and can be detected by an ISFET sensor in a sensor array. As such, a change in pH correlated with the known sequential order of nucleotide reagent flows can be used to indicate the order of nucleotides complementary to a polynucleotide sample on particle or bead that had been prepared for sequencing a target polynucleotide sample.

FIG. 3B illustrates generally a schematic representation of the fluidic integration of fluidic multiplexer unit 200 of fluidic multiplexer block 100 of FIG. 1 with a multilane sensor device.

Regarding fluidic delivery and control for performing various analyses on a multilane sensor device, such as sensor device 10 of FIG. 3B, fluidic circuit 215 of fluidic multiplexer unit 200 can be in fluid communication with one flow cell lane of sensor device 10. For the purpose of illustration, one fluidic multiplexer unit is shown fluidically integrated with one flow cell lane in FIG. 3B. However, an end user can select any number or combination of lanes during an analysis, as each lane is fluidically integrated with one of a fluidic multiplexer unit, such as fluidic multiplexer units 200A through 200D of FIG. 1. By way of a non-limiting example, a first flow cell lane, such as flow cell lane 4A of sensor device 10 of FIG. 3B, can be fluidically integrated with a first fluidic multiplexer, such as fluidic multiplexer unit 200A of FIG. 1, while a second flow cell lane, such as flow cell lane 4B of sensor device 10 of FIG. 3B can be fluidically integrated to a second fluidic multiplexer, such as fluidic multiplexer unit 200B of FIG. 1. Similarly, a third flow cell lane, such as flow cell lane 4C of sensor device 10 of FIG. 3B, can be fluidically integrated with a third fluidic multiplexer, such as fluidic multiplexer unit 200C of FIG. 1, while a fourth flow cell lane, such as flow cell lane 4D of sensor device 10 of FIG. 3B can be fluidically integrated to a fourth fluidic multiplexer, such as fluidic multiplexer unit 200D of FIG. 1. In that regard, for illustrative purposes for FIG. 3B, what is described herein pertains generally to how each fluidic multiplexer unit 200 is fluidically integrated with each of a corresponding flow cell lane of a multilane sensor device.

As will be provided subsequently in more detail herein, a fluidic system of a sequencer instrument can include a plurality of solution containers providing a variety of solutions for use over the course of a sequencing run. For example, various solutions can include various nucleotide reagents used in analysis, a calibration solution, a diluent (wash) solution, and a cleaning solution. Various solutions used over the course of a sequencing run can be in controllable fluid communication with any flow cell lane of sensor device 10 via a flow cell inlet, such as flow cell inlet 3A of flow cell lane 4A of FIG. 3B. A fluidic system of a sequencer instrument of the present teachings can include a fluid line from each of a solution container, which can be selectively placed in fluid communication with an inlet channel of fluidic circuit 215, such as inlet channels 211,217,223,229, 235, and 242. Additionally, as depicted in FIG. 3B, each of various solutions used over the course of an analysis can have fluid flow controlled by a valve, such as fluid line valves V₁ through V₆ for each of reagent fluid lines L₁ through L₄, as well as for calibration solution line L₅ and wash solution line L₆, respectively. It should be noted that calibration fluid line valve V₅ is generally in a closed position except during a calibration sequence before a run is initiated for calibrating a sensor device selected for use during a run. Accordingly, calibration fluid line valve V₅ is closed during a sequencing run.

In conjunction with controllable flow of various solutions used over the course of an analysis, fluidic multiplexer unit 200 of FIG. 3B can perform fluidic operations that include, for example, but not limited by, providing selected reagent delivery to a flow cell lane of sensor device 10, washing of fluidic multiplexer circuit 215, as well as a flow cell, such as flow cell lane 4A of sensor device 10, and priming of fluidic multiplexer circuit 215 with a selected reagent. Such fluidic operations can provide for cross contamination-free delivery of reagents to a flow cell, such as flow cell lane 4A of FIG. 3B, can provide for sharp transitions between reagent fluid streams, as well as providing a constant electrolyte fluidic environment for reference electrode 275, shown in FIG. 3B to be in fluid communication with central channel 250, thereby providing a constant stable reference voltage to sensor device 10.

For example, fluidic multiplexer unit 200 of FIG. 3B can selectively provide fluid communication between any of reagent fluid lines L₁ through L₄ and first flow cell inlet 3A of first flow cell lane 4A, thereby providing selective reagent flow through first flow cell lane 4A of sensor device 10. A non-limiting illustrative reagent fluidic path is given by a reagent delivery operation in which wash solution fluid line valve V₆ is in a closed state, and one of reagent fluid line valves V₁ through V₄ is in an open state, providing that one of a selected reagent is in fluid communication with fluidic multiplexer circuit 215. Under such a condition, a selected reagent can flow through fluidic multiplexer circuit 215 and then through waste channel 246 to waste. Additionally, a selected reagent can flow through fluidic multiplexer circuit 215 to first flow cell inlet 3A of first flow cell lane 4A, where it can then flow through first flow cell lane 4A to first outlet port 5A, and finally through a flow cell outlet line (see FIG. 2) to a flow cell waste container.

With respect to fluidic control of a wash solution, fluidic multiplexer unit 200 of FIG. 3B can selectively provide fluid communication between a wash solution and first flow cell lane 4A. As such, with wash solution fluid line valve V₆ in an open state, a wash solution line L₆ can be in fluid communication with fluidic multiplexer waste channel 246, as well as with flow cell waste channel (see FIG. 1), providing that washing of fluidic multiplexer circuit 215 and first flow cell lane 4A can be done. A non-limiting illustrative wash solution fluidic path is given by a washing operation in which wash solution fluid line valve V₆ is in an open state, and each of reagent fluid line valves V₁ through V₄ is in a closed state, providing that a wash solution can flow through wash solution fluid channel 242 to a tee junction with central channel 250. As central channel 250 is in fluid communication with waste channel 246 through fluidic multiplexer circuit 215, wash solution can flow to fluidic multiplexer waste through waste channel 246. As will be provided subsequently in more detail herein, wash solution can through first flow cell lane 4A from first inlet port 3A to first outlet port 5A, and then to a flow cell waste container.

Priming of fluidic multiplexer circuit 215 of fluidic multiplexer unit 200 can be done with a selected reagent, for example, in sequence after a washing operation and before the selected reagent is placed in fluid communication with first flow cell lane 4A of FIG. 3B. A non-limiting example illustrative of reagent priming is given by a reagent priming operation in which solution fluid line valve V₆ is in an open state, and one of reagent fluid line valves V₁ through V₄ is selected to be in an open state, providing that one of a selected reagent is in fluid communication with fluidic multiplexer circuit 215 of fluidic multiplexer unit 200. Under such an operation, the flow rate of the wash solution relative to the flow rate of the reagent is selected so that wash solution flows through wash channel 242 and through first flow cell lane 4A of sensor device 10 to sensor device waste. Under such conditions, the selected reagent circulates through fluidic multiplexer circuit 215, as it is blocked from flowing through sensor device 10 by the wash solution flow through the device. As such, the selected reagent flows through fluidic multiplexer circuit 215 through waste channel 246 to a main waste. Accordingly, when a reagent delivery operation as previously provided herein is initiated, the reagent selected in the reagent priming operation is in direct flow communication with first flow cell inlet 3A.

As such, various embodiments of fluidic systems are configured to execute a sequence of operations for the sequential delivery of various solutions to a sensor device over the course of a next generation sequencing analysis. For example, a sequence of operations can include washing, priming and nucleotide reagent delivery through a fluidic multiplexer block unit to a sensor device, such as depicted in FIG. 3B. Using a fluidic multiplexer block of the present teachings for fluid distribution to a sensor device during a sequence of fluidic operations can avoid cross-contamination of reagents in various fluidic compartments, as well as provide sharp transitions between reagent fluid streams. Additionally, various embodiments of fluidic systems provide a constant electrolyte fluidic environment for a reference electrode, thereby providing a constant stable reference voltage to a sensor device.

FIG. 4 illustrates generally fluidic multiplexer block assembly 110, includes fluidic multiplexer block 100 and each of a fluidic interface block assembly 300, 310, 320 and 330. Each interface block assembly can include a fluidic interface block, such as fluidic interface blocks 302, 312, 322, and 332 of fluidic interface block assembly 300, 310, 320 and 330, respectively. Each fluidic interface block has a first set of flexible tubing and a second set of flexible tubing connected to the block, such as first and second flexible tubing sets 304 and 306 connected to fluidic interface block 302, first and second flexible tubing sets 314 and 316 connected to fluidic interface block 312, first and second flexible tubing sets 324 and 326 connected to fluidic interface block 322, and first and second flexible tubing sets 334 and 336 connected to fluidic interface block 332.

As depicted in FIG. 4, each fluidic interface block is mounted to a face of fluidic multiplexer block 100 so that each fluidic line in each set of flexible tubing can be coupled and sealed to a respective inlet port in a complementary set of ports. For example, in FIG. 4, fluidic interface block assembly 300 is shown mounted upon first face 102, while fluidic interface block assembly 310 is shown mounted upon opposing second face 104 of fluidic multiplexer block 100. Similarly, fluidic interface block assemblies 320 and 330 are shown mounted upon third face 106, which adjoins first face 103 and second face 104 of fluidic multiplexer block 100. For each fluidic interface block, each fluidic line in each set of flexible tubing can be coupled and sealed to a respective inlet port in a complementary set of ports on each face of fluidic multiplexer block 100. For example, as shown in the exploded view of FIG. 1, each fluidic multiplexer unit 200A through 200B provides a first set of ports and a second set of ports for an assembled fluidic multiplexer block.

In that regard, fluidic interface block assembly 300 mounted upon fluidic multiplexer block first face 102 has first and second flexible tubing sets 304 and 306. For each fluidic multiplexer block unit of fluidic multiplexer block 100, each tube of flexible tubing set 304 is connected to a corresponding first reagent inlet port, such as first nucleotide reagent inlet port 210 of fluidic multiplexer unit 200 of FIG. 2, while each tube of flexible tubing set 306 is connected a corresponding second reagent inlet port, such as second nucleotide inlet port reagent 216 of fluidic multiplexer unit 200 of FIG. 2. As depicted in FIG. 4, fluidic interface block assembly 310, mounted upon fluidic multiplexer block second face 104, has first and second flexible tubing sets 314 and 316. For each fluidic multiplexer block unit of fluidic multiplexer block 100, each tube of flexible tubing set 314 is connected a corresponding third reagent inlet port, such as third nucleotide reagent inlet port 222 of fluidic multiplexer unit 200 of FIG. 2, while each tube of flexible tubing set 316 is connected a corresponding fourth reagent inlet port, such as fourth nucleotide reagent inlet port 228 of fluidic multiplexer unit 200 of FIG. 2. As such, each tube of flexible tubing set 304 can be coupled and sealed to a first set of ports on first face 102, while each tube of flexible tubing set 306 can be coupled and sealed to a second set of ports on first face 102. In a corresponding fashion, each tube of flexible tubing set 314 can be coupled and sealed to a first set of ports on second face 104, while each tube of flexible tubing set 316 can be coupled and sealed to a second set of ports on second face 104.

Similarly, FIG. 4 depicts fluidic interface block assembly 320 mounted upon fluidic multiplexer block third face 106, which is orthogonal to and adjoining first face 102 and second face 104. Fluidic interface block assembly 320 has first and second flexible tubing sets 324 and 326. For each fluidic multiplexer block unit of fluidic multiplexer block 100, each tube of flexible tubing set 324 is to connected a corresponding sensor device waste outlet port, such as sensor device waste outlet port 264 of fluidic multiplexer unit 200 of FIG. 2, while each tube of flexible tubing set 326 is connected to a corresponding wash solution inlet port, such as wash solution inlet port 240 of fluidic multiplexer unit 200 of FIG. 2. As depicted in FIG. 4, fluidic interface block assembly 330, mounted upon fluidic multiplexer block third face 106, has first and second flexible tubing sets 334 and 336. For each fluidic multiplexer block unit of fluidic multiplexer block 100, each tube of flexible tubing set 334 is connected to a corresponding main waste outlet port, such as main waste outlet port 266 of fluidic multiplexer unit 200 of FIG. 2, while each tube of flexible tubing set 336 is connected to a corresponding calibration solution inlet port, such as calibration solution inlet port 234 of fluidic multiplexer unit 200 of FIG. 2. As such, each tube of flexible tubing set 324 can be coupled and sealed to a first set of ports on third face 106, while each tube of flexible tubing set 326 can be coupled and sealed to a second set of ports on third face 106. Similarly, each tube of flexible tubing set 334 can be coupled and sealed to a third set of ports on third face 106, while each tube of flexible tubing set 336 can be coupled and sealed to a fourth set of ports on third face 106.

Finally, as depicted in FIG. 4, fluidic multiplexer block fourth face 108, opposing fluidic multiplexer block third face 106, has a sensor device interface inlet connector port and a sensor device interface outlet connector port for each fluidic multiplexer unit of fluidic multiplexer block 100, as exemplified in FIG. 2, which depicts sensor device interface inlet connector ports 260A through 260D, and sensor device interface outlet connector ports 262A through 262D on fluidic multiplexer block fourth face 108.

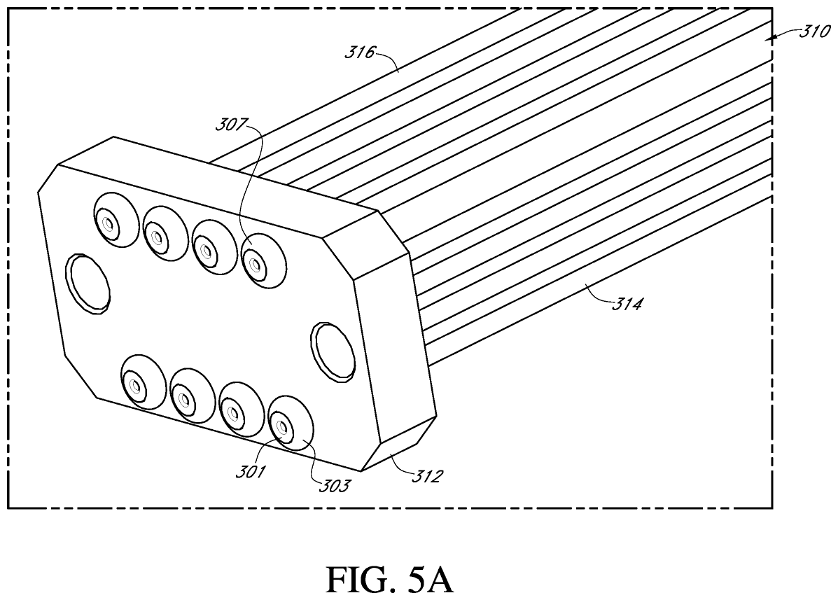

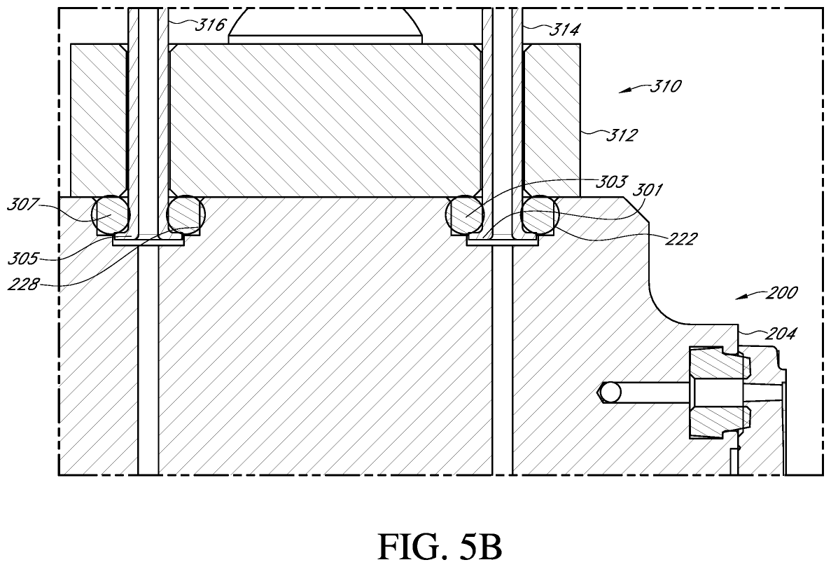

As previously provided herein, once mounted upon fluidic multiplexer block 100, each fluidic line in each set of flexible tubing is coupled and sealed to an inlet port of a fluidic multiplexer unit. FIG. 5A illustrates generally fluidic interface block assembly 310 with fluidic interface block 312 including first flexible tubing set 314 and second flexible tubing set 316 connected to fluidic interface block 312. As depicted in FIG. 5A, each tube in the set of flexible tubing has a flanged tubing connection, such any of the tubing of flexible tubing sets 314 with flanged tubing connection 301. Additionally, each flanged tubing connection has an O-ring mounted thereupon, such as O-ring 303 of FIG. 5A mounted upon flanged tubing connection 301. FIG. 5B illustrates generally the sealing of each tube of a set of tubes of a fluidic interface assembly, such as fluidic interface assembly 310 of FIG. 4, in each corresponding inlet port of a fluidic multiplexer unit, such as fluidic multiplexer unit 200 of FIG. 2. FIG. 5B is a partial section view of a fluidic multiplexer unit, such as fluidic multiplexer unit 200 of FIG. 2, upon which fluidic interface block 312 is mounted. FIG. 5B depicts a partial section view through fluidic interface block 312 and fluidic interface side 204, which shows flange 301 fit into reagent inlet port 222 and the connection between flexible tubing set 314 and reagent inlet port 222 effectively sealed by O-ring 303. Similarly, FIG. 5B shows flange 305 fit into nucleotide reagent inlet port 228 and the connection between flexible tubing set 316 and nucleotide reagent inlet port 228 effectively sealed by O-ring 307.

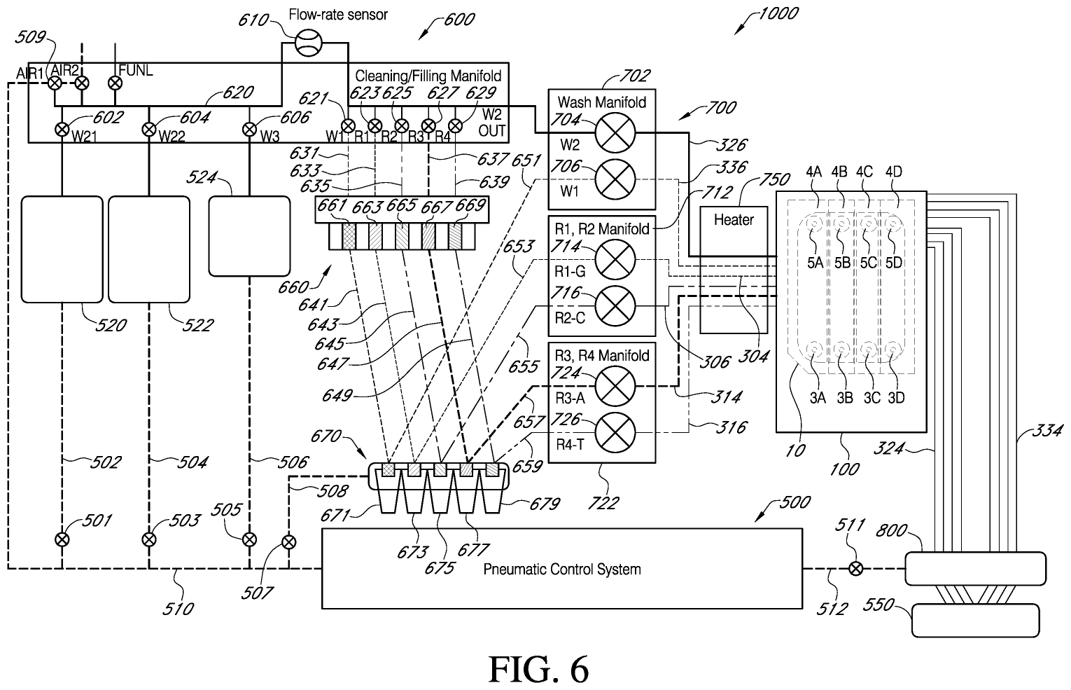

FIG. 6 is a schematic representation that illustrates generally fluidic control system 1000 of a sequencing system of the present teachings. As depicted in FIG. 6, fluidic control system 1000 has pneumatic control system 500, as well as fluid handling control systems, such as fluid handling manifold 600 and fluid distribution manifold assembly 700.

In that regard, pneumatic control system 500 is in fluid communication with first wash solution container 520 through first pneumatic inlet line that is controlled via valve 501, with second wash solution container 522 through second pneumatic inlet line 504 that is controlled via valve 503, and with cleaning solution container 524 through third pneumatic inlet line 506 that is controlled via valve 505. Similarly, pneumatic control system 500 is in fluid communication with bulk container assembly 670 via fourth pneumatic inlet line 508 that is controlled via valve 507. With respect to fluidic system control, pneumatic control system 500 is in fluid communication with fluid handling manifold 600 via fifth pneumatic inlet line 510 that is controlled via valve 509. Finally, pneumatic control system 500 is in fluid communication with pinch manifold 800 via sixth pneumatic inlet line 512 that is controlled via valve 511.

As will be provided subsequently in more detail herein, pneumatic control system 500 and pinch manifold 800, in conjunction with flow rate sensor 610 together constitute a fluid regulation and control system that provides regulation and control, for example, between various input source containers and an output container. In that regard, various embodiments of a fluid regulation and control system of the present teachings can provide a defined and controllable pressure difference between input source containers holding various solutions used for a sequencing run, which can include various nucleotide reagents used in analysis, a calibration solution, a wash solution and a cleaning solution, and an output container. Accordingly, a fluid regulation and control system of the present teachings can provide a defined and controllable pressure difference between various solutions in input sources containers such as first wash solution container 520, second wash solution container 522, cleaning solution container 524, and bulk container assembly 670, and an output container, such as waste container 550. As such, a defined and controlled pressure difference provides a defined and controlled flow rate of various reagents and solutions used over the course of an analysis through various fluid circuits of fluidic control system 1000. Flow rates may include rates of approximately 15 μl/s for single lane sensor device flow, approximately 30 μl/s for main waste flow; 45 μl/s for the combination of single lane sensor device and main waste flow, 180 μl/s for full sensor device and main waste flow, and over 300 μl/s during system cleaning operations.

Fluid handling manifold 600 provides control for the distribution of various solutions used in cleaning and filling operations. As depicted in FIG. 6, fluid handling manifold 600 has fluid handling manifold line 620 which is in fluid communication with flow rate sensor 610. According to the present teachings, flow rate sensor 610 provides dynamic input to pneumatic control system 500 for calibrating a defined flow rate for various fluid circuits of fluidic control system 1000 using pinch manifold 800, and for providing a defined volume of flow when filling various containers in bulk container assembly 670, for example nucleotide reagent containers 673-679, as well as calibration solution container 671. With respect to liquid input sources, first wash solution container 520 is in fluid communication with fluid handling manifold 600 through first wash solution outlet line 530, while second wash solution container 522 is in fluid communication with fluid handling manifold 600 through second wash solution outlet line 532 and cleaning solution container 524 is in fluid communication with fluid handling manifold 600 through calibration solution outlet line 534.

In order to provide sufficient reagent volume for the massively parallel processing performed during next generation sequencing, fluidic control system 1000 is configured to provide a substantial volume of various reagents and solutions used over the course of various analyses using a sensor device, such as sensor device 10 of FIG. 3A. To provide perspective, the volume of various reagents and solutions provided can be, for example, between 10,000 times to 100,000 times greater than the flow cell volume of a sensor device. In that regard, reagent concentrate cartridge 660 is in fluid communication with wash solution containers 520 and 522. As used herein, a wash solution is an aqueous-based solution of stable electrolyte composition, which can be used as a solvent in the preparation of a calibration solution and sequencing reagents, during the calibration of a sensor device before a sequencing run, for a washing operation of fluidic manifold block as previously provided herein, as well as used for continually refreshing electrolyte solution around a reference electrode. Reagent concentrate cartridge 660 can include calibration solution concentrate container 661, while the remaining concentrates are nucleotide reagent concentrates. For example, first nucleotide reagent concentrate container 663 can contain a deoxyguanosine triphosphate (dGTP) reagent concentrate, while second nucleotide reagent concentrate container 665 can contain a deoxycytidine triphosphate (dCTP) reagent concentrate, and third nucleotide reagent concentrate container 667 can contain a deoxyadenosine triphosphate (dATP) reagent concentrate, while fourth nucleotide reagent concentrate container 669 can contain a deoxythymidine triphosphate (dTTP) reagent concentrate. Reagent concentrate cartridge 660 is also in fluid communication with bulk container assembly 670.

Accordingly, each container of bulk container assembly 670 holds a substantial volume of calibration solution used for determining the time signal will be generated spatially across a sensor device, as well as dNTP reagents used in high-throughput sequencing. For example, each container in bulk container assembly 670 can have a volume of between about 200 ml to about 300 ml to support a diluted volume for the bulk calibration solution and each bulk nucleotide reagent of between about 140 ml to about 160 ml, of which approximately 35 ml to about 135 ml can be used for a sequencing run, depending on end user setup of a sequencing run. In general, a volume of a bulk container can be selected, for example, by applying an appropriate dilution factor for the volume of concentrated reagents in a reagent concentrate cartridge, and allowing enough headspace to accommodate a pressure sufficient to provide a defined and controlled flow rate of various solutions used over the course of an analysis through various fluid circuits of fluidic control system 1000.

Regarding wash solution containers 520 and 522, given that during a sequencing run the wash solution can be used as a solvent in the preparation of various reagents, as well as used for continually refreshing electrolyte solution around a reference electrode, the volume of wash solution used for a sequencing run can be, for example, a maximum of about 2.5 liters, depending on end user setup of a sequencing run, so that each wash solution container can be about 1.5 to about 2 liters. In general, a volume of a wash solution container can be selected, for example, by taking into consideration the multiple uses of wash solution during unattended operation of a sequencing system, and applying the appropriate time and flow rate factors, such time according to the flow rates previously provided herein, and allowing enough headspace to accommodate a pressure sufficient to provide a defined and controlled flow rate of wash solution through fluidic control system 1000.

Finally, regarding cleaning solution container 524, between 500 ml to about 700 ml of cleaning solution can be used for various cleaning procedures using the cleaning solution, so that cleaning solution container 524 can have a volume of between about 600 ml to about 800 ml, which can provide sufficient headspace to accommodate a pressure sufficient to provide a defined and controlled flow rate of cleaning solution through fluidic control system 1000.

Before the initiation of sequencing runs, the bulk preparation of a calibration solution and nucleotide reagents can be done. Regarding the bulk preparation of a calibration solution, with valves 602 and 621 of fluid handling manifold 600 open, and all other fluid handling manifold valves closed, wash solution in wash solution container 520 can flow into fluid handling manifold line 620 through wash solution outlet line 530 and into calibration solution concentrate container 661 through calibration concentrate line 631, and then into calibration solution container 671 through calibration solution inlet line 641. Wash solution can continue to flow through calibration solution concentrate container 661 to calibration solution container 671 for a predetermined fill volume of calibration solution container 671, at which point calibration solution concentrate container 661 has been effectively exhausted of calibration solution concentrate.

Next, the bulk preparation of a first nucleotide reagent can be done by having valves 602 and 623 of fluid handling manifold 600 open, and all other fluid handling manifold valves closed, so that wash solution in wash solution container 520 can flow into fluid handling manifold line 620 and into first nucleotide reagent concentrate container 663 through first nucleotide reagent concentrate line 633, and then into first nucleotide reagent container 673 through first nucleotide reagent inlet line 643 until first nucleotide reagent container 673 is filled.

After the bulk preparation of the first nucleotide reagent is complete, the bulk preparation of a second nucleotide reagent can be done by having valves 602 and 625 of fluid handling manifold 600 open, and all other fluid handling manifold valves closed, so that wash solution in wash solution container 520 can flow into fluid handling manifold line 620 through wash solution outlet line 530 and into second nucleotide reagent concentrate container 665 through second nucleotide reagent concentrate line 635, and then into second nucleotide reagent container 675 through second nucleotide reagent inlet line 645 until second nucleotide reagent container 675 is filled.

Following the bulk preparation of a second nucleotide reagent, the bulk preparation of a third nucleotide reagent can be done by having valves 602 and 627 of fluid handling manifold 600 open, and all other fluid handling manifold valves closed, so that wash solution in wash solution container 520 can flow into fluid handling manifold line 620 through wash solution outlet line 530 and into third nucleotide reagent concentrate container 667 through third nucleotide reagent concentrate line 637, and then into third nucleotide reagent container 677 through third nucleotide reagent inlet line 647 until third nucleotide reagent container 677 is filled.

Finally, the bulk preparation of a fourth nucleotide reagent can be done by having valves 602 and 629 of fluid handling manifold 600 open, and all other fluid handling manifold valves closed, so that wash solution in wash solution container 520 can flow into fluid handling manifold line 620 through wash solution outlet line 530 and into fourth nucleotide reagent concentrate container 669 through fourth nucleotide reagent concentrate line 639, and then into fourth nucleotide reagent container 679 through fourth nucleotide reagent inlet line 649 until fourth nucleotide reagent container 679 is filled.

With sufficient calibration solution and nucleotide reagents prepared for high-throughput next generation sequencing-by-synthesis run, fluid distribution manifold assembly 700 can control the distribution of various solutions through a fluidic multiplexer block and into a sensor device, and finally into a waste container. For example, fluid distribution manifold assembly 700 can control the distribution of various solutions in bulk container assembly 670, as well as wash solution in wash solution containers 520, 522, through fluidic multiplexer block 100 and into sensor device 10, and finally into waste 530 through sensor device waste lines 324 or main waste lines 334 (see, for example, FIG. 4). More specifically, during a sequencing run, fluid distribution manifold assembly 700 can control the sequential order of flows of nucleotide reagents (i.e. dNTP reagents) in bulk container assembly 670 through fluidic multiplexer block 100 and into sensor device 10, and then finally to waste. The flow of dNTP reagents through a selected lane or lanes of a flow cell, such as flow cell 6 of sensor device 10 of FIG. 3A, can be done in any determined flow order during a sequencing run.

As depicted in FIG. 6, fluid distribution manifold assembly 700 can include solution distribution manifold 702, reagent distribution manifold 712, and reagent distribution manifold 722. Heater block 750 of FIG. 6 can be in contact with flexible tubing sets 304, 306, 314, 316, 326, and 336 to ensure uniform temperature of solutions and reagents before flowing through fluidic multiplexer block 100 and sensor device 10.

Solution distribution manifold 702 can have a first set of valves in valve block 704, which can individually control the fluid communication between fluid handling manifold line 620 and flexible tubing set 326. As depicted for fluidic multiplexer block assembly 110 of FIG. 4, each tube of flexible tubing set 326 is connected to a corresponding wash solution inlet port of a corresponding fluidic multiplexer unit, such as wash solution inlet port 240 of fluidic multiplexer unit 200 of FIG. 2. Additionally, solution distribution manifold 702 can have a second set of valves in valve block 706, which can individually control the fluid communication between calibration solution line outlet 651 and flexible tubing set 336. As depicted for fluidic multiplexer block assembly 110 of FIG. 4, each tube of flexible tubing set 336 is connected to a corresponding calibration solution inlet port of a corresponding fluidic multiplexer unit, such as calibration solution inlet port 234 of fluidic multiplexer unit 200 of FIG. 2.

To provide a flow of wash solution through a selected lane or through selected lanes of a multilane sensor device, either of valves 602 or 604 of fluid handling manifold 600 can be open, while all other valves in fluid handling manifold 600 are closed. Either one valve, all four valves or any combination of valves in valve block 704 of solution distribution manifold 702 can be open, so wash solution from either containers 520 and 522 can flow into fluid handling manifold line 620 through either wash solution outlet line 530 or 532, respectively, to be distributed by a corresponding fluidic multiplexer block unit to one lane, all lanes or any combination of lanes, depending on the selection of valves in valve block 704. To provide a flow of calibration solution through a selected lane or through selected lanes of a multilane sensor device, all valves in fluid handling manifold 600 are closed. Either one valve, all four valves or any combination of valves in valve block 706 of solution distribution manifold 702 can be open, so calibration solution from calibration solution container 671 can flow into calibration solution line outlet 651 to be distributed by a corresponding fluidic multiplexer block unit to one lane, all lanes or any combination of lanes, depending on the selection of valves in valve block 706.

Reagent distribution manifold 712 can have a first set of valves in valve block 714, which can individually control the fluid communication between first nucleotide reagent outlet line 653 and flexible tubing set 304. As depicted for fluidic multiplexer block assembly 110 of FIG. 4, each tube of flexible tubing set 304 is connected to a corresponding first nucleotide reagent inlet port of a corresponding fluidic multiplexer unit, such as first nucleotide reagent inlet port 210 of fluidic multiplexer unit 200 of FIG. 2. Additionally, reagent distribution manifold 712 can have a second set of valves in valve block 716, which can individually control the fluid communication between second nucleotide reagent outlet line 655 and flexible tubing set 306. As depicted for fluidic multiplexer block assembly 110 of FIG. 4, each tube of flexible tubing set 306 is connected to a corresponding second nucleotide reagent inlet port of a corresponding fluidic multiplexer unit, such as second nucleotide reagent inlet port 216 of fluidic multiplexer unit 200 of FIG. 2.

By way of an example, to provide a flow of first nucleotide reagent through a selected lane or through selected lanes of a multilane sensor device, all valves in fluid handling manifold 600 are closed. Either one valve, all four valves or any combination of valves in valve block 714 of distribution manifold 712 can be open, so first nucleotide reagent from first nucleotide reagent container 673 can flow into first nucleotide reagent outlet line 653 to be distributed by a corresponding fluidic multiplexer block unit to one lane, all lanes or any combination of lanes, depending on the selection of valves in valve block 714. To provide a flow of second nucleotide reagent through a selected lane or through selected lanes of a multilane sensor device, all valves in fluid handling manifold 600 are closed. Either one valve, all four valves or any combination of valves in valve block 716 of distribution manifold 712 can be open, so second nucleotide reagent from second nucleotide reagent container 675 can flow into second nucleotide reagent outlet line 655 to be distributed by a corresponding fluidic multiplexer block unit to one lane, all lanes or any combination of lanes, depending on the selection of valves in valve block 716.

Reagent distribution manifold 722 can have a first set of valves in valve block 724, which can individually control the fluid communication between third nucleotide reagent outlet line 657 and flexible tubing set 314. As depicted for fluidic multiplexer block assembly 110 of FIG. 4, each tube of flexible tubing set 314 is connected to a corresponding third nucleotide reagent inlet port of a corresponding fluidic multiplexer unit, such as third nucleotide reagent inlet port 222 of fluidic multiplexer unit 200 of FIG. 2. Additionally, reagent distribution manifold 722 can have a second set of valves in valve block 726, which can individually control the fluid communication between fourth nucleotide reagent outlet line 659 and flexible tubing set 316. As depicted for fluidic multiplexer block assembly 110 of FIG. 4, each tube of flexible tubing set 316 is connected to a corresponding fourth nucleotide reagent inlet port of a corresponding fluidic multiplexer unit, such as fourth nucleotide reagent inlet port 228 of fluidic multiplexer unit 200 of FIG. 2.

By way of an example, to provide a flow of third nucleotide reagent through a selected lane or through selected lanes of a multilane sensor device, all valves in fluid handling manifold 600 are closed. Either one valve, all four valves or any combination of valves in valve block 724 of distribution manifold 722 can be open, so third nucleotide reagent from third nucleotide reagent container 677 can flow into third nucleotide reagent outlet line 657 to be distributed by a corresponding fluidic multiplexer block unit to one lane, all lanes or any combination of lanes, depending on the selection of valves in valve block 724. To provide a flow of fourth nucleotide reagent through a selected lane or through selected lanes of a multilane sensor device, all valves in fluid handling manifold 600 are closed. Either one valve, all four valves or any combination of valves in valve block 726 of distribution manifold 722 can be open, so fourth nucleotide reagent from fourth nucleotide reagent container 679 can flow into fourth nucleotide reagent outlet line 659 to be distributed by a corresponding fluidic multiplexer block unit to one lane, all lanes or any combination of lanes, depending on the selection of valves in valve block 726. Though an order of flows was provided in this example, it should be noted that the sequence of dNTP flows can be done in any determined flow order during a sequencing run.

A schedule of various cleaning procedures for all fluidic components in fluidic control system 1000 can be performed.

For example, a between-run cleaning providing flushing of used lanes can be done to clean previously used lanes. For example, once a sequencing run has been complete, and a sensor device still has unused lanes, fluidic control system 1000 of FIG. 6, can flush cleaning solution from cleaning solution container 524 through fluidic pathways 632-639, as well as fluidic pathways 642-649 and 652-659, which are eventually in fluid communication through fluidic multiplexer block 100 with one or more lanes that had been selected by an end user for sequencing, and then finally to sensor device waste and to main waste, for example, through sensor device waste lines 324 and main waste lines 334. After sufficient volume of cleaning solution has been flushed through the system, sensor device 10 can be further processed for another sequencing run.

Additionally, a schedule of cleaning for all fluidic components in fluidic control system 1000 can be performed. Such cleaning is typically performed after all lanes of a sensor device have been sequenced, or prior to a new sensor device being installed on the system. Cleaning can be performed with an exhausted reagent concentrate cartridge and a used multilane sensor device in place. With valve 606 open, each of valves 623 through 629 of fluid handling manifold 600 can be sequentially opened, and all of the valves in a set of valves of a corresponding valve block of fluid distribution manifold assembly 700 can be opened. With such a flow path sequentially executed for each fluidic path of the calibration solution and of each nucleotide reagent, cleaning solution from cleaning solution container 524 can flow sequentially through every fluidic component of fluidic control system 1000 to waste container 550. Finally, a drying procedure is done in order to leave the system ready for next use. For a drying procedure, valves 602, 604 and 606 closed and all other valves of fluid handling manifold 600 are open, and all valves of fluid distribution manifold assembly 700 are open. In that configuration, clean dry air is passed through the fluid handling components of fluidic control system 1000 to drive remaining liquid to waste container 550.

As previously provided herein, pneumatic control system 500 and pinch manifold 800, in conjunction with flow rate sensor 610 together constitute a fluid regulation and control system that provides regulation and control, for example, between various input source containers and an output container. In that regard, various embodiments of a fluid regulation and control system of the present teachings can provide a defined and controllable pressure difference between input source containers holding various solutions used for a sequencing run, which can include various nucleotide reagents used in analysis, a calibration solution, a wash solution and a cleaning solution, and an output container. Accordingly, a fluid regulation and control system of the present teachings can provide a defined and controllable pressure difference between various solutions in input sources containers such as first wash solution container 520, second wash solution container 522, cleaning solution container 524, and bulk container assembly 670, and an output container, such as waste container 550.

With respect components of a fluid regulation and control system, for various embodiments of fluidic control system 100, pinch manifold 800 can contain eight pinch regulators, each constructed as described in U.S. Pat. No. 9,375,716. These devices operate essentially as three port pressure followers, with an input fluidic port, output fluidic port, and control pneumatic port. With a defined waste line fluidic resistance connected between the pinch regulator output fluidic port and waste container 550, the pressure on the output fluidic port will be approximately equal to the pressure on the pinch regulator control pneumatic port, regardless of the pressure on the input fluidic port. The flow rate through the pinch regulator will then be equal to the output fluidic port pressure divided by the waste line fluidic resistance. In order to precisely calibrate the flow rates, the fluidic control system 1000 is configured to allow wash solution to flow to the desired pinch regulator on pinch manifold 800. A set of known pneumatic pressures are applied to each pinch regulator pneumatic control port, and the flow sensor 610 measures the precise flow rate corresponding to the pneumatic control pressure. A table of flow rates vs. pneumatic control pressures is then stored for each pinch regulator, which can be utilized by the instrument software to deliver any desired flow rate precisely.

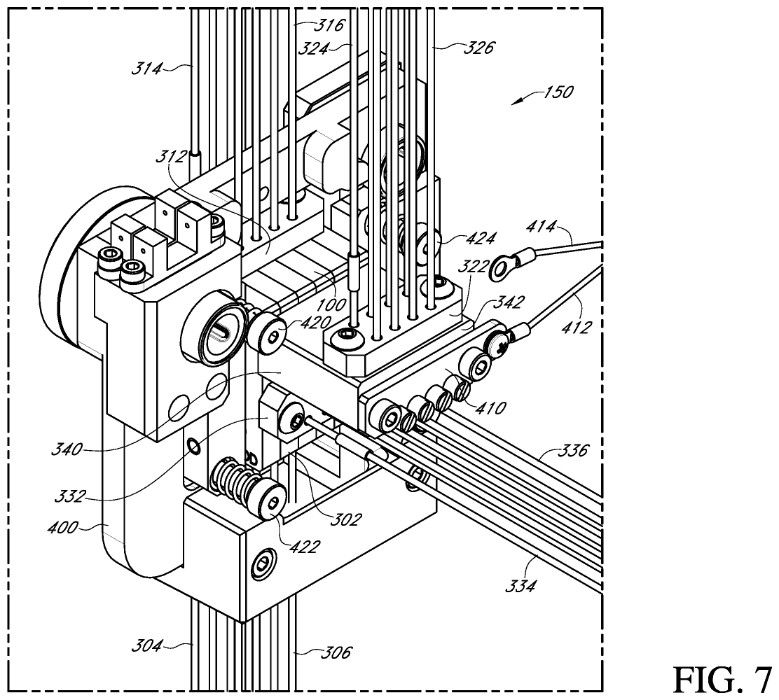

FIG. 7 is a back isometric view that illustrates generally fluidic multiplexer block clamp assembly 150. As depicted in FIG. 7, fluidic multiplexer block clamp assembly 150 includes fluidic multiplexer block clamp 400 with fluidic multiplexer block assembly 110 mounted therein. Fluidic multiplexer block clamp 400 can include electrode connection mounting plate 410 mounted on side 342 of electrode adapter fluidic interface block 340. Electrode connection mounting plate 410 enables connection of electrical lead 412 and ground lead 414 to electrode adapter fluidic interface block 340 of fluidic multiplexer block clamp assembly 150. Fluidic multiplexer block clamp 400 also includes shoulder screws 420, 422, and 424, as well as a fourth shoulder screw that is placed below shoulder screw 424 and opposite shoulder screw 422. The force on the shoulder screws of fluidic multiplexer block clamp 400 is set to provide four degrees of movement to a fluidic multiplexer block mounted therein to provide flexibility of the docking of a fluidic multiplexer block to a multilane sensor device.

Regarding fluidic multiplexer block assembly 110 mounted in fluidic multiplexer block clamp 400, as depicted in FIG. 7, the orientation of fluidic multiplexer block 100 and fluidic block connections shows fluidic interface block 312 mounted to fluidic multiplexer block 100 at the top of fluidic multiplexer block clamp assembly 150, while fluidic interface block 302 is mounted to fluidic multiplexer block 100 at the bottom of fluidic multiplexer block clamp assembly 150. As depicted in FIG. 7, the orientation of first and second flexible tubing sets 314 and 316 emanate likewise from the top of fluidic multiplexer block clamp assembly 150, while first and second flexible tubing sets 304 and 306 emanate likewise from the bottom of fluidic multiplexer block clamp assembly 150. Similarly, fluidic interface block 332 is mounted to fluidic multiplexer block 100 at the back of fluidic multiplexer block clamp assembly 150, and below electrode adapter fluidic interface block 340. As depicted in FIG. 7, the orientation of first and second flexible tubing sets 334 and 336 emanate likewise from the back of fluidic multiplexer block clamp assembly 150. Finally, fluidic interface block 322 is mounted to fluidic multiplexer block 100 at the back of fluidic multiplexer block clamp assembly 150, and upon electrode adapter fluidic interface block 340. As depicted in FIG. 7, the orientation of first and second flexible tubing sets 324 and 326 emanate likewise from the top of electrode adapter fluidic interface block 340.

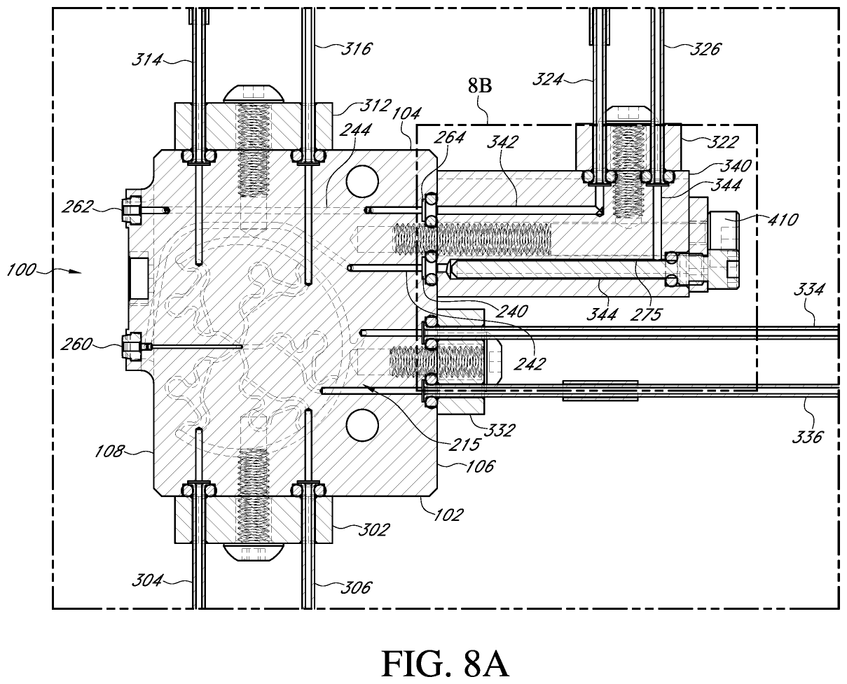

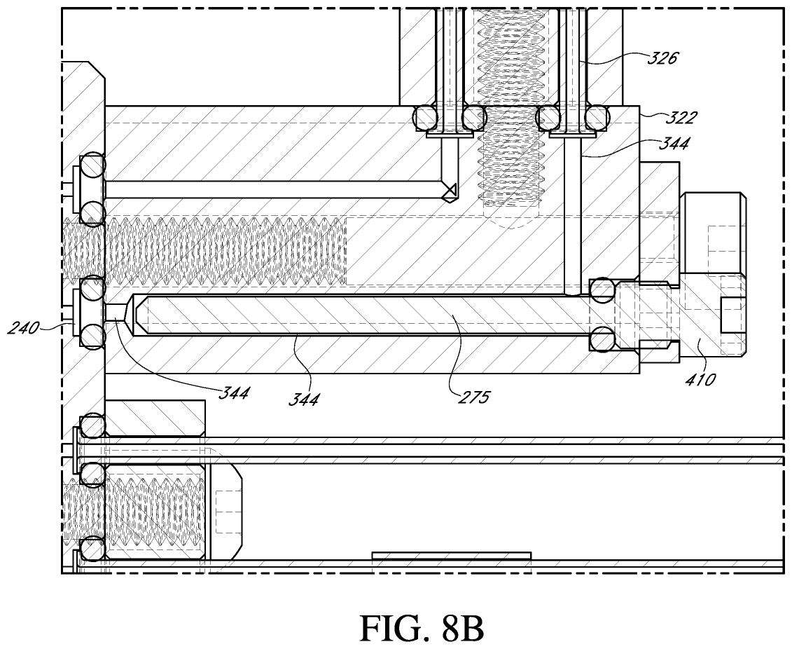

FIG. 8A and FIG. 8B are a section views that illustrate generally orientation of fluidic multiplexer block 100 as it is mounted in a fluidic multiplexer block clamp assembly, as well as the integration of an electrode into a fluidic multiplexer unit. Regarding the orientation of fluidic multiplexer block 100 as it is mounted in a fluidic multiplexer block clamp assembly, as depicted in FIG. 8A, it is a 90° counter clockwise rotation of fluidic multiplexer block assembly 110 of FIG. 4. In that regard, fluidic multiplexer block first face 102 is depicted with fluidic interface block 302 mounted thereupon and with first and second flexible tubing sets 304 and 306 connected to fluidic interface block 302, while fluidic multiplexer block second face 104, which opposes fluidic multiplexer block first face 102, is depicted with fluidic interface block 312 mounted thereupon and with first and second flexible tubing sets 314 and 316 connected to fluidic interface block 312. Similarly, fluidic multiplexer block third face 106 is depicted with fluidic interface block 332 mounted thereupon and with first and second flexible tubing sets 334 and 336 connected to fluidic interface block 332. Additionally, fluidic multiplexer block third face 106 is depicted with electrode adapter fluidic interface block 340 mounted thereupon. As depicted in FIG. 8A, fluidic interface block 322 is mounted upon electrode adapter fluidic interface block 340 so that first and second flexible tubing sets 324 and 326 connected to fluidic interface block 332 are in fluid communication with electrode adapter fluidic interface block inlet channels 342 and 344, respectively. In that regard, electrode adapter fluidic interface block 340 is mounted to fluidic multiplexer block third face 106, so that electrode adapter fluidic interface block inlet channels 342 and 344 are coupled and sealed to sensor device waste outlet port 264 and wash solution inlet port 240, respectively. Finally, as depicted in FIG. 8A, fluidic multiplexer block fourth face 108 has sensor device interface inlet connector port 260 and sensor device interface outlet connector port 262 As previously provided herein, fluidic multiplexer block fourth face 108 has a corresponding set of sensor device interface inlet connector ports and sensor device interface outlet connector ports for each fluidic multiplexer unit of fluidic multiplexer block 100. As will be provided subsequently in more detail herein, sensor device interface inlet connector port 260 and sensor device interface outlet connector port 262 are coupled and sealed to an inlet port and outlet port, respectively, of a multilane sensor device.

Regarding providing an electrode connection to each fluidic multiplexer unit, which provides a constant, stable reference electrode voltage to a multilane sensor device, FIG. 8A depicts a section view of electrode adapter fluidic interface block 340 with electrode connection mounting plate 410 mounted thereupon. FIG. 8A depicts electrode 275 in an enlarged bore of in a section of electrode adapter fluidic interface block inlet channel 344, which provides for fluid passage through electrode adapter fluidic interface block inlet channel 344, which is in fluid communication with wash solution channel 242. Electrode 275 is electrically coupled to a voltage source connected to electrode connection mounting plate 410 through electrical lead 412 and ground lead 414 (see FIG. 7). As was previously provided herein, second flexible tubing set 326 is in fluid communication with a source of a wash solution of stable electrolyte composition. As such, electrode 275 is in a fluidic environment that provides a constant, stable reference electrode voltage to a multilane sensor device. FIG. 8B is an expanded view of electrode adapter fluidic interface block 340, which depicts electrode 275 in an enlarged bore of in a section of electrode adapter fluidic interface block inlet channel 344, and depicts electrode 275 coupled to electrode connection mounting plate 410. As depicted in FIG. 8A, electrode adapter fluidic interface block inlet channel 344 is in fluid communication with flexible tubing set 326 and is coupled and sealed to wash solution inlet port 240, which as previously provided herein is in fluid communication with a wash solution channel of a fluidic multiplexer unit. For example. as depicted in FIG. 2, wash solution inlet port 240 is in fluid communication with wash solution channel 242 of fluidic multiplexer unit 200.

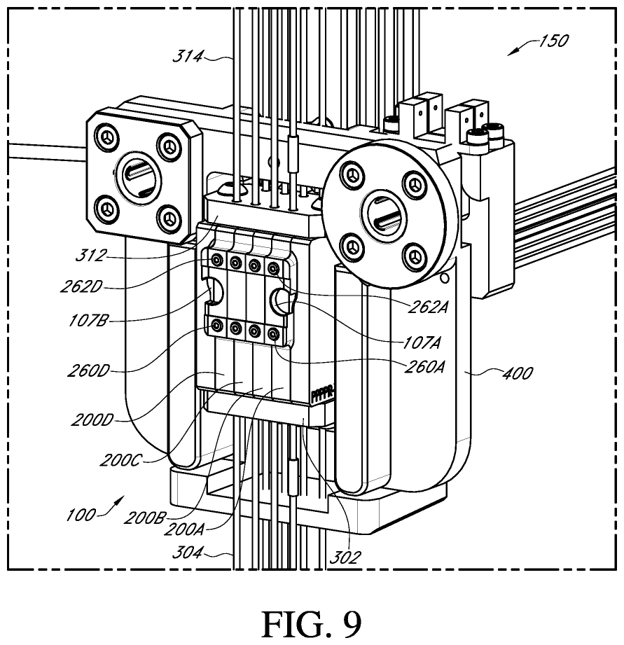

FIG. 9 is a front isometric view that illustrates generally fluidic multiplexer block clamp assembly 150 that includes fluidic multiplexer block clamp 400 with fluidic multiplexer block assembly 110 mounted therein. As depicted in FIG. 9, fluidic multiplexer block fourth face 108 of fluidic multiplexer block 100 has sensor device interface inlet connector ports 260A though 260D and sensor device interface outlet connector ports 262A though 262D for each fluidic multiplexer unit 200A, 200B, 200C and 200D, respectively. First alignment notch 107A of first fluidic manifold unit 200A, and second alignment notch 107B of fourth fluidic manifold unit 200D are configured to assist in the alignment and sealing process of fluidic multiplexer block clamp assembly 150 to a multilane sensor device. As previously provided herein, fluidic multiplexer block clamp 400 provides four degrees of movement to a fluidic multiplexer block mounted therein to provide flexibility of the docking of the fluidic multiplexer block to a multilane sensor device. Additionally, first alignment notch 107A and second alignment notch 107B are configured to provide self-alignment of a multilane sensor device to a multilane sensor device, so that sealing of sensor device interface inlet connector ports and sensor device interface outlet connector ports, such as sensor device interface inlet connector ports 260A though 260D and sensor device interface outlet connector ports 262A though 262D can be done to the respective inlet ports and outlet ports of a multilane sensor device.

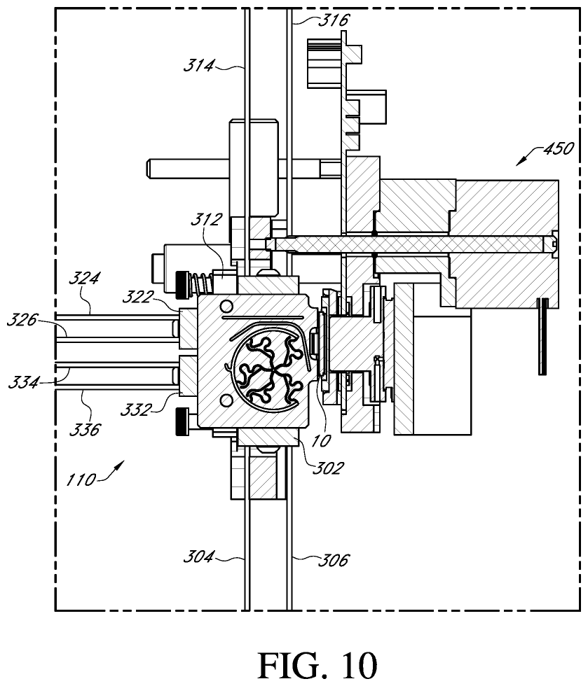

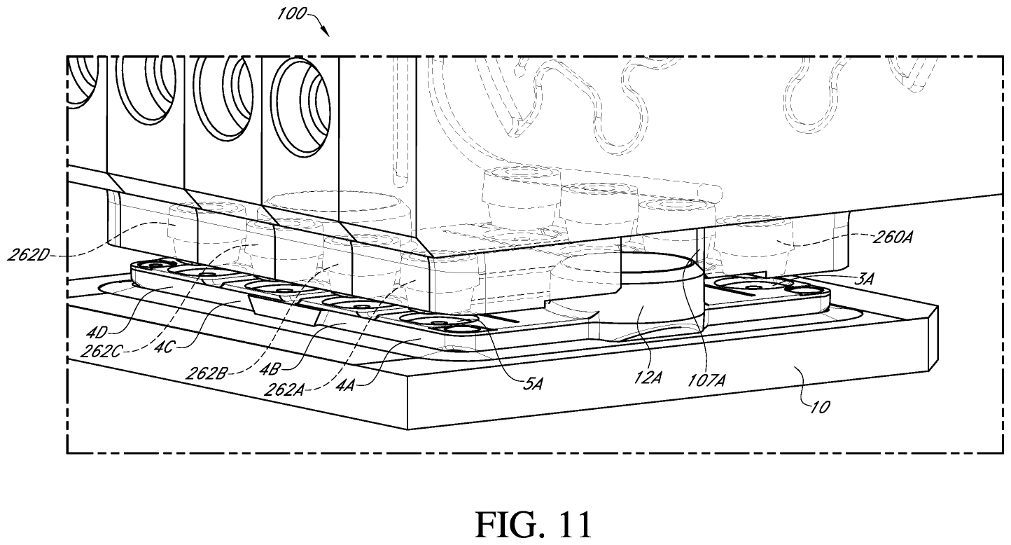

FIG. 10 is a section view that illustrates generally fluidic multiplexer block assembly 110 mounted to multilane sensor device 10, such as multilane sensor device 10 schematically depicted in FIG. 3B. As depicted in FIG. 10, multilane sensor device 10 which is mounted to sensor device mounting and positioning assembly 450. The positions of fluidic interface blocks 302, 312, 322, and 332 of fluidic multiplexer block assembly 110 are also evident in the section view of FIG. 10. When fluidic multiplexer block assembly 110 is mounted to multilane sensor device 10, for each lane of a multilane sensor device, coupling and sealing of each sensor device interface inlet connector port and each sensor device interface outlet connector port to each corresponding sensor device inlet port and each sensor device outlet port, respectively, is done. In that regard, FIG. 11 is an expanded isometric view that illustrates generally the mounting and sealing of a fluidic multiplexer block to a multilane sensor device. As depicted in FIG. 11, sensor device 10 has lanes 4A through 4D, each lane having an inlet port and an outlet port, as exemplified for lane 4A with inlet port 3A and outlet port 5A. In FIG. 11, the juxtaposition of first alignment pin 12A of sensor device 10 and first alignment notch 107A of fluidic multiplexer block 100 shows how the complementary pair engage for alignment of sensor device 10 with fluidic multiplexer block 100. Additionally, FIG. 11 depicts how each inlet port and each outlet port of sensor device 10 can be coupled and sealed to each corresponding sensor device interface inlet connector port and each sensor device interface outlet connector port of fluidic multiplexer block 100. In FIG. 11, this is exemplified for lane 4A, in which the juxtaposition of first inlet port 3A to sensor device interface inlet connector port 260A and first outlet port 5A to sensor device interface outlet connector port 262A can be coupled and sealed to each once sensor device 10 and fluidic multiplexer block 100 have been completely engaged with one another. Such compression coupling and sealing provide for ready decoupling of fluidic multiplexer block 100 from sensor device device 10.

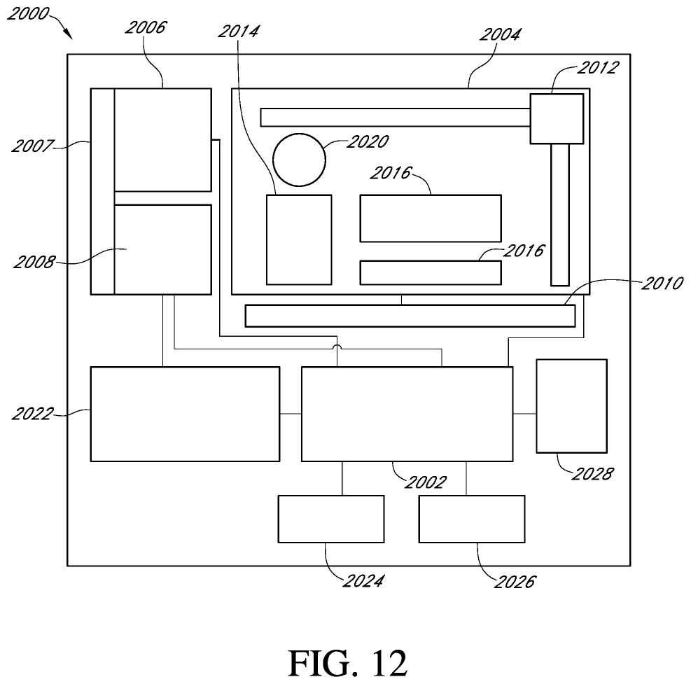

FIG. 12 is a block diagram that illustrates generally a sequencing system of the present teachings, which can be a sequencing system incorporating a sample preparation platform. As depicted in FIG. 12, sequencing system 2000 can include controller 2002 in communication with sample preparation deck 2004, loading station 2006, and sequencing station 2008. Sample preparation deck 2004 can include pipetting robot 2012, which can be a three-axis pipetting robot. Pipetting robot 2012 can access samples 2014, reagents and solutions 2016, thermocycler 2018 and other devices 2020, such as a magnetic separator or a centrifuge. Target sequences of a sample to be analyzed on sequencing system 2000 can be prepared at sample preparation deck 2004, and then can be provided to the loading station 2006. For example, sample preparation deck 2004 can provide library preparation of a sample to be analyzed, as well as preparation of target sequences from a library, which can be used to prepare a sample of particles or beads. Such a sample of particles or beads can then be provided to loading station 2006 to be loaded onto a sensor device, such as sensor device 10 of FIG. 3A.

Once loaded, the sensor device can be transported to sequencing station 2008 using slide mechanism 2007, which can move a sensor device from a loading position to a sequencing position. Sequencing station 2008 can include both fluidic and electronic interfaces to automatically process a sample loaded on a sensor device during a sequencing run. Container cabinet 2010 can house containers holding various reagents and solutions used in a sequencing run, as well housing various waste containers. Data gathered from the sensing device can be provided to sequencing computer 2022, which can perform base calling, read alignment, and variant calling.

Controller 2002 can further communicate with a user interface, such as a monitor, keyboard, mouse, touchscreen, or any combination thereof, among other interfaces, such as user interface 2024 of FIG. 12. Further, controller 2002 can communicate with a network interface that may access a local area network, wide area network, or global network. Network interface 2026 can be a wired interface or a wireless interface using various standard communication protocols. Sequencing system 2000 can be powered by power source 2028.

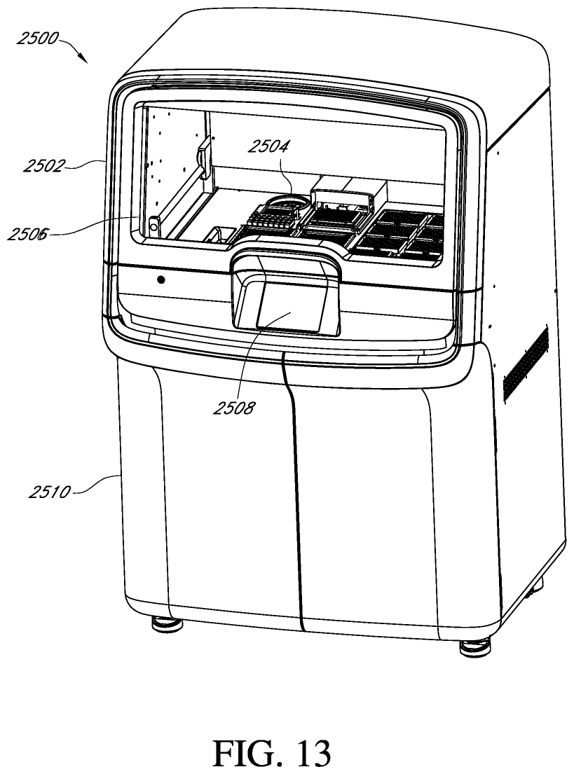

FIG. 13 is a perspective view that illustrates generally a sequencing system of the present teachings. Sequencing system 2500 of FIG. 13 can be a sequencing system with various components as described for sequencing system 2000 of FIG. 12. Sequencing system 2500 can include upper portion 2502 and lower portion 2504. Upper portion 2502 can include door 2506 to access sample preparation deck 2504 on which samples to be analyzed, reagent containers, and other consumables can be placed, for example, as described for FIG. 12. Lower portion 2504 can include a container cabinet, such as container cabinet 2010 of FIG. 12. In addition, various embodiments of a sequencing system, such as sequencing system 2500, can include a user interface, such as a touchscreen display 2508.

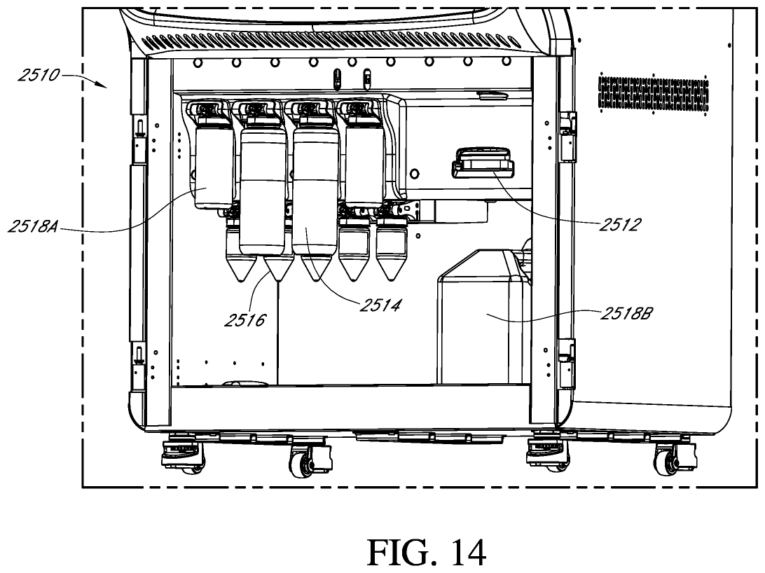

FIG. 14 illustrates generally container cabinet 2510, which can be a component of a sequencing system, such as sequencing system 2000 of FIG. 12 and sequencing system 2500 of FIG. 13. Container cabinet 2510 can be useful in the management of fluidic processing for a sequencing system. For example, as depicted in FIG. 13, container cabinet 2510 includes reagent cartridge loading interface 2512 for loading a reagent concentrate cartridge, such as reagent concentrate cartridge 660 of FIG. 6. Moreover, container cabinet 2510 can house various containers for holding reagents, and solutions. For example, a wash solution and a cleaning solution can be held in containers of first container assembly 2514 of FIG. 12, such as depicted for containers 520, 522 and 524 of FIG. 6. Further, bulk nucleotide reagents, as well as a bulk calibration solution can be held in containers of second container assembly 2516 of FIG. 14, for example, such as depicted for bulk container assembly 670 of FIG. 6. As depicted in FIG. 6, second container assembly 2516 of FIG. 14 can be in fluid communication with fluidic multiplexer block 100 as shown in FIG. 6, such as through flexible tubing sets 304, 306, 314, 316, and 336. Fluidic multiplexer block 100 as shown in FIG. 6 is fluidically coupled to sensor device 10, which can be an ISFET device used for sequencing-by-synthesis. Additionally, a container cabinet can house various sample preparation waste, sensor waste and main waste containers for collecting effluent. For example, first waste container 2518A can collect effluent generated during sample preparation, such as effluent generated from sample preparation deck 2004 of sequencing system 2000 of FIG. 12 and sample preparation deck 2504 of FIG. 13. Additionally, second waste container 2518B of FIG. 14 can collect effluent generated from a fluidic system, such as fluidic system 100 of FIG. 6, for example, during a sequencing run, such as through sensor device waste lines 324 and main waste lines 334 of FIG. 6.

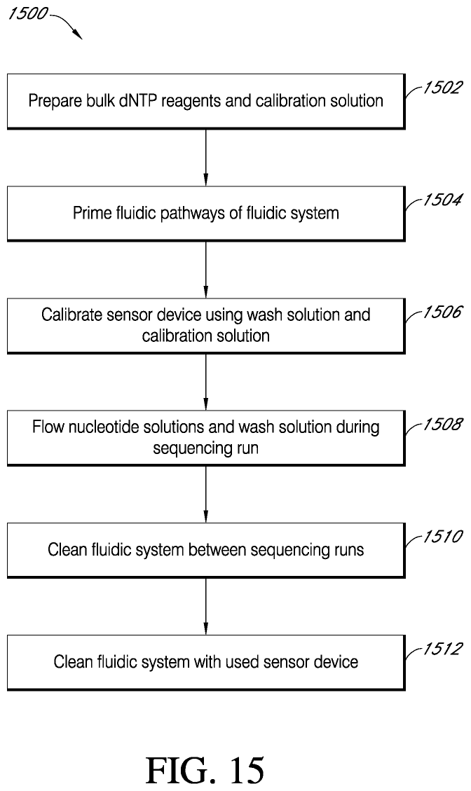

FIG. 15 illustrates generally a flow diagram of a method for automated fluidic system workflow of an automated sequencing system. Method 1500 of FIG. 15 can be utilized on a sequencing system, such as sequencing system 2000 of FIG. 12 and sequencing system 2500 of FIG. 13, which can include an automated fluidic control system, such as fluidic control system 1000 of FIG. 6. For method 1500 of FIG. 15, sensor device can be automatically moved from a loading position once loaded with a sample of particles or beads that have been prepared for sequencing to a sequencing position, for example, using slide mechanism 2007 of FIG. 12.

Before the initiation of an automated sequencing run, the preparation of bulk calibration and nucleotide reagents can be done, as indicated at step 1502 of FIG. 15. As previously described herein, an end user can select one lane of a sensor device in any position used singly during a run, all lanes used simultaneously during a run, or any combination of lanes to be used simultaneously during a run, so that a sensor device can be used for more than one sequencing run. As such, as a sensor device can be used for more than one sequencing run, a substantial volume of bulk calibration solution and nucleotide reagents can be prepared with the installation of a new sensor device by an end user. With respect to workflow at step 1502, by way of a non-limiting example, when using a new sensor device, an end user can insert a new reagent concentrate cartridge, such as reagent concentrate cartridge 660 of FIG. 6, into a sequencing system, for example, into reagent cartridge loading interface 2512 of sequencing system 2500 of FIG. 13. Then, as part of a presequencing step 1502, the preparation of bulk calibration solution and dNTP reagents is automatically performed, so as to provide bulk volume of calibration solution and dNTP reagents for massively parallel processing performed by an automated sequencing system, such as sequencing system 2000 of FIG. 12 and sequencing system 2500 of FIG. 13. As depicted in FIG. 6 and previously described herein, concentrate from each concentrate container, such as concentrate containers 661-669 of reagent concentrate cartridge 660 of FIG. 6, is precisely diluted into each respective bulk container, such as containers 671-679 of bulk container assembly 670 of FIG. 6. In various embodiments, bulk container assembly 670 as depicted in FIG. 6 can be an assembly of conical containers, such as depicted in second container assembly 2516 of FIG. 13.

With respect to automated fluidic system workflow at step 1504, a second presequencing step includes the priming of fluidic pathways. For example, in reference to FIG. 6, priming fluidic pathways can include pathways providing fluid communication between wash solution containers 520-522 and fluidic pathways 631-639, as well as fluidic pathways 641-649 and 651-659, which are eventually in fluid communication with sensor device 10 through fluidic multiplexer block 100. Finally, fluidic pathways from a fluidic multiplexer block are in fluid communication with sensor device waste and main waste, for example, through sensor device waste lines 324 and main waste lines 334 as described for and depicted in FIG. 4, FIG. 6 and FIG. 7. According to the present teachings, priming step 1504 can be done to prepare a sequencing system for a sequencing run by properly filling all pathways and ensuring that they are bubble-free, as well as priming a fluidic multiplexer block, such as fluidic multiplexer block 100 of FIG. 6, in preparation of the initiation of a sequencing run.

In an exemplary automated workflow of step 1504, dNTP reagent priming of fluidic pathways can be done to prime pathways with sequential dNTP reagent flows through one or more lanes of a sensor device designated by an end user as active lanes for a sequencing run. For example, with respect to sensor device 10 of FIG. 3A, an end user can select any one of four lanes used singly during a run, all four lanes used simultaneously in any order during a run, or any combination of lanes to be used simultaneously in any order during a run. In that regard, if an end user selects any single lane of a sensor device for a sequencing run, dNTP reagent priming will be performed for the active lane selected, while if all lanes are selected to be run in any order, then dNTP priming and filling will be performed for all active lanes, and finally, if 2 to 3 lanes are selected to run in any order, priming and filling will be done for the 2-3 active lanes selected. For example, in reference to FIG. 6, reagent priming of fluidic pathways can include pathways providing fluid communication between wash solution containers 520-522 and fluidic pathways 632-639, as well as fluidic pathways 642-649 and 652-659, which are eventually in fluid communication with one or more of an active selected lane of sensor device 10 through fluidic multiplexer block 100. Finally, the reagents flow from fluidic multiplexer block 100 to sensor device waste and to main waste, for example, through sensor device waste lines 324 and main waste lines 334 of FIG. 6.

After priming the fluidic system, calibration of sensor device can be done at step 1506 of FIG. 15 as a third presequencing step. As described for an depicted in FIG. 3B, FIG. 8A and FIG. 8B, a reference electrode 275 provides a constant an stable reference voltage for a sensor device, such as sensor device 10 of FIG. 3A and FIG. 3B. Before a sequencing run is automatically initiated, an automated fluidic system, such as fluidic control system 1000 of FIG. 6, provides a flow of wash solution over a reference electrode and through a sensor device while a reference electrode provides a constant and stable voltage. Under such conditions, parameters required for the function of a sensor device, such as an chemFET sensor device or ISFET sensor device can be determined. Additionally, a sensor device, such as sensor device 10 of FIG. 3A and FIG. 3B, can be calibrated using a calibration solution, such as calibration solution 671 of FIG. 6. In an embodiment, a calibration solution is selected to provide a sensor response, such as providing a pH change to an ISFET sensor device. As a flow of calibration solution is passed over a sensor device, a calibration of the time in which a signal can be generated spatially across a sensor device during the flow of a nucleotide reagent can be determined.

With a sequencing system primed and calibrated, a sequencing run can be initiated. Sequential flows of nucleotide solution and wash solution during a sequencing run at step 1508 can be provided by an automated fluidic system, such previously described herein for fluidic control system 1000 of FIG. 6. In an example, fluidic control system 1000 can control the sequence of nucleotide reagent flow through control of the fluidic pathways between wash solution containers 520-522 and fluidic pathways 632-639, as well as fluidic pathways 642-649 and 652-659, which are eventually in fluid communication with sensor device 10 through fluidic multiplexer block 100. The sequential order nucleotide reagent flows over end-user selected active lanes of a sensor device can be done in any determined flow order during a sequencing run, and finally from a fluidic multiplexer block to sensor device waste and to main waste, for example, through sensor device waste lines 324 and main waste lines 334 of FIG. 6.

Once a sequencing run has been complete, and a sensor device still has unused lanes, cleaning of the fluidic system between run at step 1510 can be done. At the end of a sequencing run, while a sensor device with unused lanes is still in sequencing position, an automated fluidic system, such as fluidic control system 1000 of FIG. 6, can provide flow of cleaning solution from a cleaning solution container through the lanes that were selected by an end user-as the active lanes during the sequencing run setup. For example, in reference to FIG. 6, cleaning of fluidic pathways between sequencing runs can include pathways providing fluid communication between cleaning solution container 524 and fluidic pathways 632-639, as well as fluidic pathways 642-649 and 652-659, which in fluid communication with fluidic multiplexer block 100. Fluidic multiplexer block 100 is in fluid communication with one or more of what had been an active lane of sensor device 10, so that cleaning solution is flushed through the used lanes, and finally to sensor device waste and to main waste, for example, through sensor device waste lines 324 and main waste lines 334 of FIG. 6. In an example in which an end user selects two lanes, such as lane 4A and lane 4C of FIG. 3A, FIG. 3B, FIG. 6 and FIG. 11, an automated fluidic system, such as fluidic control system 1000 of FIG. 6, can flush cleaning solution through lane 4A and lane 4C after the end of the sequencing run. After sufficient volume of cleaning solution has been flushed through the system, the fluidic system can be depressurized to remove liquid from the lines, so that the sensor device can be decoupled from a fluidic multiplexer block, such as described for and depicted in FIG. 10 and FIG. 11. Once decoupled from a fluidic multiplexer block, a sensor device with unused lanes can automatically be moved from a sequencing position to a loading position, for example, using slide mechanism 2007 of FIG. 12. When positioned in a loading position, a sensor device with unused lanes can be loaded for a subsequent sequencing run according to a user-defined run plan with a sample of particles or beads that have been prepared for sequencing. Once loaded and returned to a sequencing position, method steps 1502 through 1510 can be repeated until, for example, a sensor device has been completely used or otherwise exhausted.

When an end user has completely used a sensor device or when the device is otherwise exhausted, and before the initialization of the system with a new sensor device, cleaning fluidic system can be done, as indicated at step 1512 of FIG. 15, and as previously described herein for fluidic control system 1000 of FIG. 6. Recalling, with an exhausted reagent concentrate cartridge and exhausted sensor device in place, and with valve 606 open, each of valves 623 through 629 of fluid handling manifold 600 can be sequentially opened, and all of the valves in a set of valve of a corresponding valve block of fluid distribution manifold assembly 700 can be opened. With such a flow path sequentially executed for each fluidic path of the calibration solution and of each nucleotide reagent, cleaning solution from cleaning solution container 524 can flow sequentially through every fluidic component of fluidic control system 1000 to waste container 550. Finally, a drying procedure is done in order to leave the system ready for next use. For a drying procedure, valves 602, 604 and 606 closed and all other valves of fluid handling manifold 600 are open, and all valves of fluid distribution manifold assembly 700 are open. In that configuration, clean dry air is passed through the fluid handling components of fluidic control system 1000 to drive remaining liquid to waste container 550.

While various embodiments of the present teachings have been shown and described herein, it will be obvious to those skilled in the art that such embodiments are provided by way of example only. Numerous variations, changes, and substitutions will now occur to those skilled in the art without departing from the present teachings. It should be understood that various alternatives to the various embodiments described herein may be employed in practicing the present disclosure. It is intended that the following claims define the scope of the present disclosure and that methods and structures within the scope of these claims and their equivalents be covered thereby.

What is claimed is:

1. A fluidic device comprising:
a fluidic multiplexer block comprising a plurality of fluidic multiplexer units, each fluidic multiplexer unit including a substrate with a fluidic distribution circuit formed therein, the fluidic distribution circuit including a plurality of fluidic branches;
a first fluidic interface block assembly connected to a first face of the fluidic multiplexer block, the first fluidic interface block including a first set of flexible tubes and a second set of flexible tubes, each set of tubes connected, respectively, to each corresponding port of a first set of ports and a second set of ports on the first face of the fluidic multiplexer block;
a second fluidic interface block assembly connected to a second face of the fluidic multiplexer block opposing the first face, the second fluidic interface block including a first set of flexible tubes and a second set of flexible tubes, each set of tubes connected, respectively, to each corresponding port of a first set of ports and a second set of ports on the second face of the fluidic multiplexer block;
a third fluidic interface block assembly connected to a third face of the fluidic multiplexer block adjoining the first face and the second face, the third fluidic interface block including a first set of flexible tubes and a second set of flexible tubes, each set of tubes connected, respectively, to each corresponding port of a first set of ports and a second set of ports on the third face of the fluidic multiplexer block; and
a fourth fluidic interface block assembly connected to the third face adjacent to the third interface block assembly, the fourth fluidic interface block including a first set of flexible tubes and a second set of flexible tubes, each set of tubes connected, respectively, to each corresponding port of a third set of ports and a fourth set of ports on the third face of the fluidic multiplexer block.

2. The fluidic device of claim 1, wherein the device is operably connected to a sequencing system.

3. The fluidic device of claim 2, wherein the first set of flexible tubes of the first fluidic interface block assembly provides fluid communication between each of a first fluidic branch of each fluidic multiplexer unit and a first nucleotide reagent source and the second set of flexible tubes of the first fluidic interface block assembly provides fluid communication between each of a second fluidic branch of each fluidic multiplexer unit and a second nucleotide reagent source.

4. The fluidic device of claim 2, wherein the first set of flexible tubes of the second first fluidic interface block assembly provides fluid communication between each of a third fluidic branch of each fluidic multiplexer unit and a third nucleotide reagent source and the second set of flexible tubes of the second fluidic interface block assembly provides fluid communication between each of a fourth fluidic branch of each fluidic multiplexer unit and a fourth nucleotide reagent source.

5. The fluidic device of claim 2, wherein the first set of flexible tubes of the third fluidic interface block assembly provides fluid communication between each of a fifth fluidic branch of each fluidic multiplexer unit and a calibration solution source and the second set of flexible tubes of the third fluidic interface block assembly provides fluid communication between each of main waste channel of each fluidic multiplexer unit and a waste container.

6. The fluidic device of claim 2, wherein the first set of flexible tubes of the fourth fluidic interface block assembly provides fluid communication between each of a wash solution channel of each fluidic multiplexer unit and a wash solution source and the second set of flexible tubes of the fourth fluidic interface block assembly provides fluid communication between each of main sensor device waste channel of each fluidic multiplexer unit and a waste container.

7. The fluidic device of claim 2, further comprising a set of sensor device interface connector ports on a fourth face of the fluidic multiplexer block.

8. The fluidic device of claim 7, wherein the set of sensor interface connector ports of the fourth face of the fluidic multiplexer block includes a set of sensor device interface inlet connector ports and a set of sensor device interface outlet connector ports.

9. The fluidic device of claim 8, wherein the fluidic device is operably connected a multi-lane sensor device, such that:
a set of sensor device inlet ports of the multi-lane sensor device is connected and sealed to each of a corresponding interface inlet connector port of the set of sensor device interface inlet connector ports of the fourth face of the fluidic multiplexer block; and
a set of sensor device outlet ports of the multi-lane sensor device is connected and sealed to each of a corresponding interface outlet connector port of the set of sensor device interface outlet connector ports of the fourth face of the fluidic multiplexer block.

10. The fluidic device of claim 1, wherein the substrate is a polymeric material selected from polycarbonate, polymethyl methacrylate, polyether imide and polyimide.

11. A fluidic control system for a sequencing system comprising:
a plurality of input source containers and at least one output container, wherein the plurality of input source containers hold solutions used for a sequencing run;
a fluidic multiplexer block assembly in a fluidic path between a fluid distribution manifold assembly and the at least one output container, wherein the fluid distribution manifold controls the distribution of the solutions used for a sequencing run; and
a fluid regulation and control system, wherein the fluid regulation and control system provides a defined and controllable pressure difference between the plurality of input source containers and the output container.

12. The fluidic control system of claim 11, further comprising:
a fluid handling manifold, wherein the fluid handling manifold controls distribution of solutions used in cleaning and filling operations.

13. The fluidic control system of claim 12, further comprising:
a reagent concentrate cartridge for preparation of bulk reagents in a bulk reagent container assembly, wherein the reagent concentrate cartridge is in a fluidic path between the fluid handling manifold and the bulk reagent container assembly.

14. The fluidic control system of claim 11, wherein the fluidic multiplexer block assembly is configured to be reversibly coupled to a sensor device.

15. A method for automated fluidic system workflow for a sequencing system, the method comprising:
preparing bulk nucleotide and calibration solutions from a reagent concentrate cartridge;
priming each of a plurality of fluid pathways of a fluidic system;
calibrating a sensor device with a wash solution and a calibration solution;
controlling flow of the nucleotide solutions and the wash solution through the sensor device during a sequencing run; and
cleaning the fluidic system between sequencing runs.

16. The method of claim 15, further comprising repeating priming trough cleaning for subsequent runs until the multilane sensor device is used or otherwise exhausted.

17. The method of claim 16, further comprising cleaning the fluidic system using a used or otherwise exhausted sensor device.
